(19) United States
(12) Patent Application Publication
(10) Pub. No.: US 2005/0224313 A1
(43) Pub. Date: Oct. 13, 2005

(54) Robust noncontact media processor

(75) Inventors: Graham Hilton, San Diego, CA (US); Peter Lo, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cubic Corporation, San Diego, CA (US)

(21) Appl. No.: 10/938,764

(22) Filed: Sep. 9, 2004

Related U.S. Application Data
(60) Provisional application No. 60/539,289, filed on Jan. 26, 2004.

(51) Int. Cl. G11B 7/085; G11B 17/22; G11B 21/08; G07F 7/00

(52) U.S. Cl. 194/211

(57) ABSTRACT

Disclosed is a media processor that may be used for controlling access to a location, such as a transit system or an amusement park. The media processor also may be used to encode information onto the token, sort a plurality of tokens, and issue tokens that have value. In one aspect of the disclosure, a media processor is disclosed for reading from, writing to, or sorting media, wherein the media processor includes an entry bezel for accepting media into the media processor, a transmitter and receiver for reading from, writing to, or sorting the media, at least one exit path for the media to exit the media processor, and a rotatable disk for moving the media from the entry bezel to the transmitter and receiver and to the at least one exit path.

### FIELD OF THE DISCLOSURE

Disclosed is a device and method for processing media that represents a certain value and, more particularly, a device and method for a processing media that represents a certain value in which the processor utilizes wireless electromechanical technologies.

### BACKGROUND OF THE DISCLOSURE

Media processors have been used for accepting media, such as tokens of value, in a variety of applications, including transit fare payment systems, amusement park entrances, and in other situations where the media processor ideally processes a Contactless Smart Card (CSC) token at a high rate of speed to maintain a relatively high rate of patron traffic flow. Typically media processors are located at the entrance and exit gates of the system or attraction and are subject to such high volume of patron traffic and to unintentional and intentional abuse by users. For example, media processors are subject to the insertion of foreign objects, including bent tokens, invalid tokens, and coins. Media processors are also subject to unintentional and intentional the spillage of drinks, such as coffee and colas. It is a challenge to provide a media processor that can remain operational while being subject to such a high volume of traffic and while being subject to user abuse.

Media processors are particularly well suited for use at automatic toll collection stations for transit fare systems, highways, bridges, tunnels, parking lots, etc. For these and other media sensing applications it is important to be able to distinguish between genuine media and counterfeits such as metallic slugs or foreign coins. A media processor ascertains when the number and denomination of the media are equal to the correct fare.

In a typical system, media such as coins, tokens, or electronic passes are detected by passing the media over a reader/writer or other validation circuit located along the path of the media. Confirmation of media validity can generate a credit. When sufficient credit is accumulated, a user may be allowed access to the transit system, bridge, or tunnel. Alternatively the media can be used in a vending machine to purchase desired items.

Typical media processors experience a number of adverse conditions. For example, the media processor may be exposed to vandalism or unintentional abuse.

Vandals may introduce liquids, such as soft drinks, water, etc. into electromechanical media processors by squirting or pouring the liquids into a receiver, such as a token slot, which can damage the media processor.

The media processor can also be subjected to jamming caused by debris that is purposely or inadvertently deposited into the mechanism. Vandalism can include packing or stuffing the receiver or media input with a blocking element such as a wad of paper, a slug, a straw, stick, or some other foreign object which can damage the media processor.

In addition to surviving the variety of adverse conditions, the media processor must operate quickly, capably and with sufficient speed to avoid creating a bottleneck that slows associated systems.

### BRIEF SUMMARY OF THE DISCLOSURE

The present disclosure is directed to an apparatus which is a robust, non-contact, media processor (RNMP), which may be used to transport any light weight electronically readable medium from one entry path, such as a token entry bezel, to multiple exit paths, wherein the exit paths terminate at a rejection container and multiple capture containers. The apparatus further includes robust fault tolerance techniques that provide protection against destructive operations. The media processor may be used for processing Contactless Smart Cards (CSC) or tokens. The media processor may be operated in several modes of operation. For example, the media processor may be installed in an entry gate, an exit gate, or a reversible gate. The media processor may also be used for CSC validation and capturing, and the CSCs can be recirculated. The media processor may be installed in a ticket vending machine (TVM), a booking office machine (BOM), and a token encoder/sorter (ES) machine. The media processor accepts, validates, and overwrites data in the CSC token, as directed by a host computer system and can divert the CSC token to one of the multiple exit paths. The disclosed media processor includes robust design features that capture, sort and return tokens under all operational conditions.

In another aspect of the disclosure, disclosed is a processor for reading information from and writing information to a medium, such as a token. The processor will be referred to generally herein as a media processor. The media processor disclosed may be used for controlling access to a location, such as a transit system or an amusement park. The media processor also may be used to sort a plurality of tokens, and issue tokens that have value. In one aspect of the disclosure, the media processor includes an intake slot for at least one medium at one time to enter the media processor, a rotating disk for accepting more than one medium at one time within the media processor, and at least one exit path.

In another aspect of the disclosure, the media processor is similar to that disclosed above but includes multiple exit paths, wherein each medium exits via a determined exit path based on the results of the processing of the medium.

In yet another aspect of the disclosure, the media processor is similar to the media processor disclosed above, but further includes at least one blocker to allow the exit of a medium or to block the exit of a medium from the disk to one of the exit paths. The exit paths may include a media rejection path to a rejection receptacle and a vault media path to capture media of value.

The media processor may include a plurality of sensors to detect a medium being inserted at the intake and to sense the passing of the medium through the exit path of the media processor.

Also disclosed is a media processor for processing a medium of value, the media processor includes an intake for accepting at least one medium at a time into the media processor, a processor for reading from, writing to, or verifying information located within or on a medium, a disk having a plurality of medium receptacles and being adapted to accept a medium from the intake, a plurality of sensors located within the media processor to determine the movement of the medium within the media processor, a plurality of exit paths, and a plurality of blockers adjacent to the disk. The blockers control the state of exit paths in an open or closed position so that media with insufficient value or invalid media may be rejected from the media processor and so that media with sufficient value or valid media may be retained.

In another aspect of the disclosure, the media processor includes a plurality of blockers to control the flow of the media from the disk to the exit paths, so that media with insufficient value or invalid media are rejected from the media processor and, so that media with sufficient value or valid media are retained within a vault located adjacent to or within the media processor.

Also disclosed is a media processor, having an intake for accepting at least one medium at one time and a processor for reading from, writing to, or verifying information located within or on a medium, a disk having a plurality of medium receptacles and being adapted to accept a medium from the intake, a plurality of sensors located along the media path within the media processor to determine the movement of the media, a plurality of exit paths from the media processor, and a plurality of blockers adjacent to the disk and exit path, the blockers controlling the state of exit paths in an open or closed position so that media with insufficient value or invalid tokens may be rejected from the media processor and so that media with sufficient value or valid media may be retained within the media processor.

The system further operates using at least one medium representing a value, the medium having readable and writable memory so that information, such as value, may be readable from and writable to the medium, the media processor being capable of encoding, sorting, verifying, or issuing media, and wherein the media processor together with the medium controls access to a system, location, or attraction by accepting the medium and permitting access to the system, location, or attraction.

In another aspect of the disclosure an media processor includes means for intaking at least one medium at one time into the media processor, means for processing at least one medium at one time, means for storing more than one medium at one time either before or after the media has been processed, and means for each medium to exit to a determined location based on the results of the processing of the medium.

Also disclosed is a method of controlling access to a location, including the steps of intaking at least one medium at one time into a media processor, processing at least one medium at one time, storing more than one medium at one time in the media processor either before or after the media have been processed, and providing exit pathways for each medium to exit the media processor to a determined location based on the results of the processing of the medium.

Also disclosed is a media processor with a unique entry bezel, wherein the entry bezel includes a first opposing surface and a second opposing surface, and wherein the first and second opposing surfaces are conical in shape to direct a medium into the processor. The entry bezel includes a plurality of grooves in the direction of travel of the medium into the media processor.

Also disclosed is a media processor with a unique rotating disc having a plurality of medium receptacles and being adapted to accept a medium from the intake. The shape of the receptacles are such that bent or damaged media is deterred from jamming in the receptacles so it can fall freely when released to the capture and reject paths. The disc receptacle wherein the first and second opposing surfaces direct a medium into and out of the disc and a plurality of grooves in the direction of travel of the medium into and out of the disc.

### BRIEF DESCRIPTION OF THE DRAWINGS

The invention will now be described in greater detail with reference to the embodiments illustrated in the accompanying drawings, in which like elements bear like reference numerals, and wherein:

FIG. 1a, FIG. 1b, FIG. 1c and FIG. 1d disclose the different modes that the media processor may be used in, according to the present disclosure, wherein FIG. 1a illustrates the media processor in a turnstile gate entry, FIG. 1b illustrates the media processor in a vending machine, FIG. 1c illustrates the media processor operating as an encoder and sorter, and FIG. 1d illustrates the media processor as utilized in a token booth.

FIG. 2 is a right-hand side perspective view of the media processor with a housing according to the present disclosure;

FIG. 3 is a partial right perspective view of the media processor with a right cover shown removed;

FIG. 4 is a right side elevational view of the media processor with the right cover shown removed;

FIG. 5 is a partial left side perspective view of the media processor with a left cover shown removed;

FIG. 6 is a cross-sectional left-hand perspective view of the media processor showing the internal mechanisms of the media processor;

FIG. 7 illustrates a left side elevational view of the media processor;

FIG. 8 illustrates a top plan view of the media processor;

FIG. 8a is a close up top plan view of the entry bezel of the media processor;

FIG. 9 illustrates a left side elevational view of the media processor, similar to FIG. 7, with a medium shown inserted into the media processor at a disk assembly;

FIG. 10 illustrates a close up left side elevational view of a token entry bezel of the media processor;

FIGS. 11a and 11b illustrate a cross-sectional side view of how the blockers cooperate with the rotating disk to either allow a token to take a certain path or not, wherein FIG. 11a illustrates the blocker in the closed position and FIG. 11b illustrates the blocker in the open position;

FIG. 12 illustrates a perspective view of the disk assembly of the media processor;

FIG. 13 illustrates an exploded view of the disk assembly of FIG. 12;

FIGS. 14a and 14b illustrate a cross-sectional view taken from line 14-14 from FIG. 9 illustrating how the blocker cooperates with the rotating disk, wherein FIG. 14a illustrates the blocker in the closed position and FIG. 14b illustrates the blocker in the open position allowing a path for the token to fall;

FIGS. 15-25 illustrate the operation of the media processor in the encoder or sorter mode;

FIGS. 26-31 illustrate the operation of the media processor in the ticket vending machine or the booking office machine mode;

FIGS. 32-46 illustrate the operation of the media processor in the gate entry mode;

FIG. 47 illustrates a close up view of the token entry bezel with two tokens being inserted into the token entry bezel simultaneously;

FIG. 48 illustrates a first medium in the disk assembly being read or overwritten by the media processor, with a second medium being inserted into the token entry bezel;

FIG. 49 illustrates the position of the disk assembly when the media processor is in the out of service mode;

FIG. 50 provides a flow diagram of the operation of the media processor in the encoder or sorter mode;

FIG. 51 provides a flow diagram of the operation of the media processor in the ticket vending machine or the booking office machine mode;

FIG. 52 provides a flow diagram of the operation of the media processor in the gate entry mode; and

FIG. 53 illustrates a functional flow diagram of a media processor according to the present disclosure.

### DETAILED DESCRIPTION OF THE DISCLOSURE

Disclosed is a media processor that may be used for controlling access to a location, such as a building, or an area, such as an amusement park, or a smaller area within a larger area. The media processor disclosed herein processes contact-less smart card (CSC) tokens, such as the shape of a circular token. The media processor disclosed includes a configuration to transport any lightweight electronically readable medium from an entry path, such as an entry bezel, to multiple exit paths, such as multiple capture containers and a rejection container. The media processor includes robust fault tolerance techniques that protect the media processor against destructive operations, such as vandalism, or unintentional acts, such as spillage of fluids into the media processor through the entry bezel.

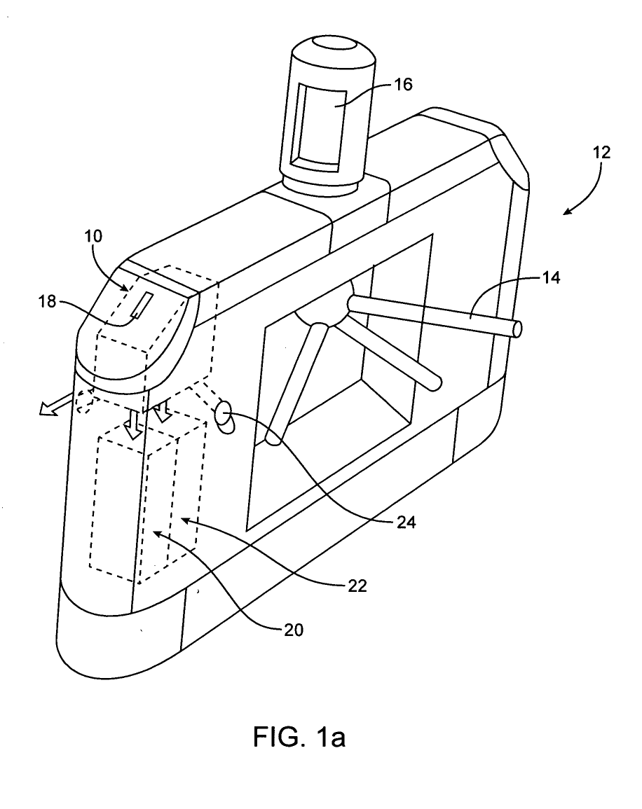

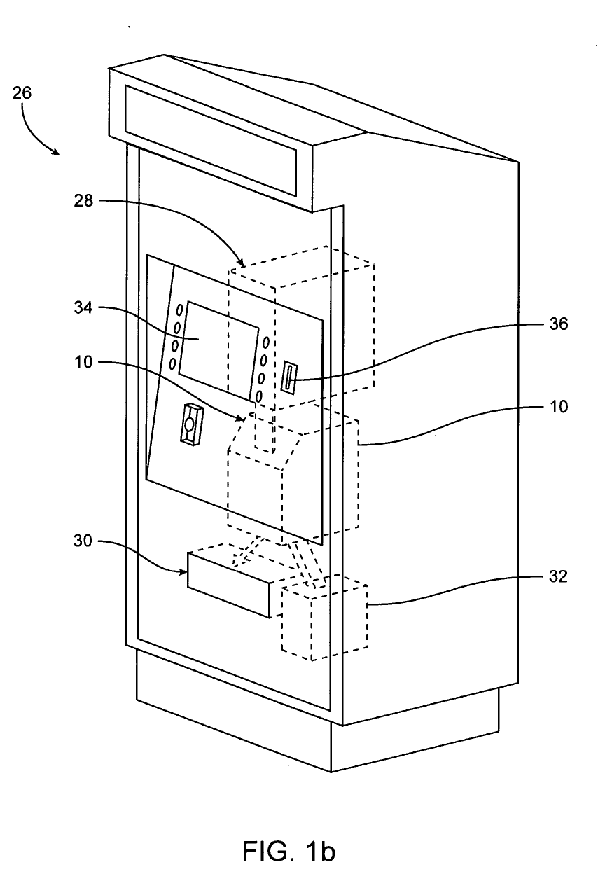

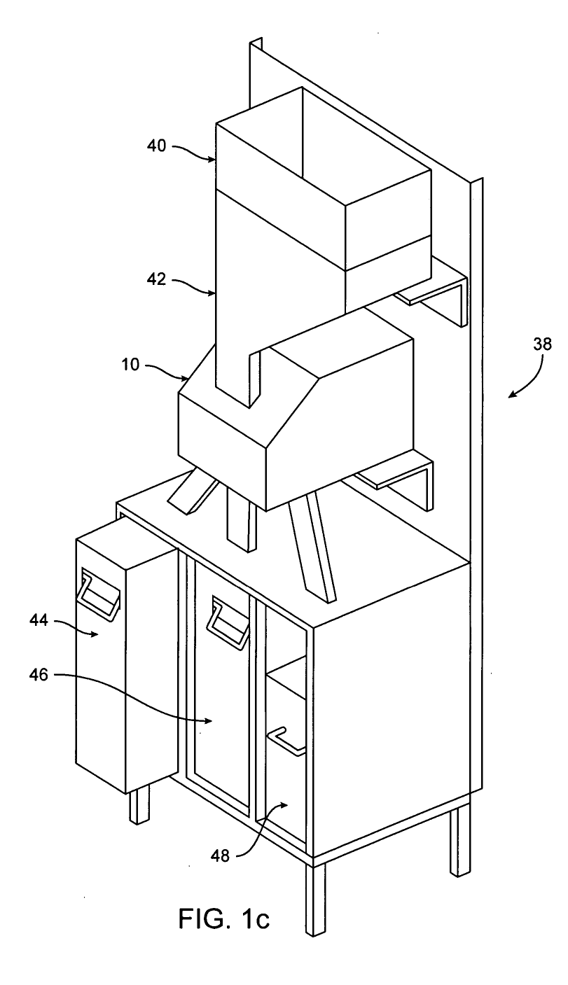

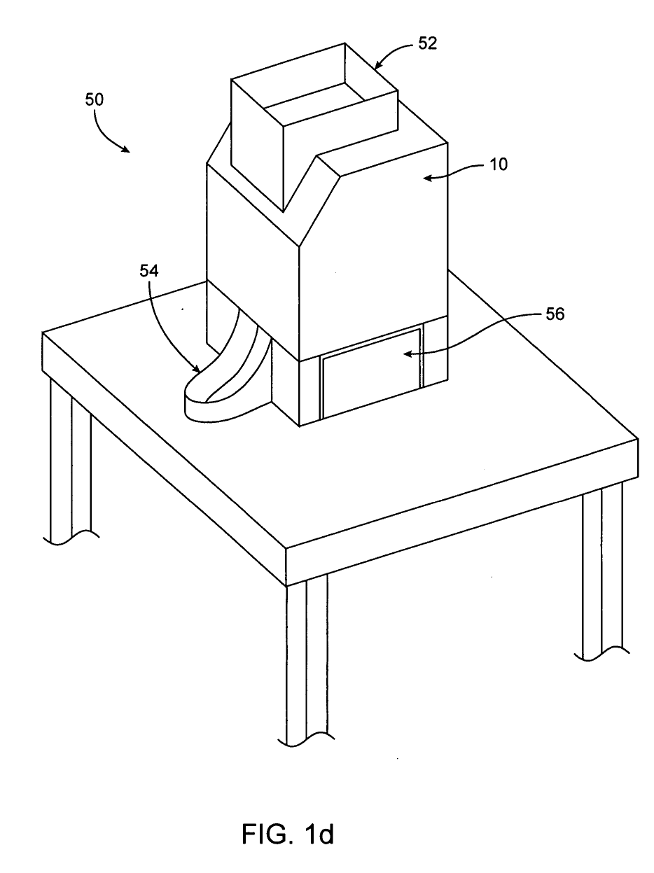

As shown in FIGS. 1A, 1B, 1C, and FIG. 1D, the media processor disclosed may be used in several modes of operation. For example, in FIG. 1, the media processor is utilized in an entry gate, shown as a turnstile gate, which may be utilized to control access to an area or a system. The turnstile gate shown in FIG. 1A may be used, for example, to allow access to a transit system, an amusement park, or an area within an amusement park or a smaller area within a larger area in any context in which controlling access to the area is dependent upon the insertion of a CSC, wherein the CSC may take many forms, such as a token. In the entry gate shown in FIG. 1A, the robust non-contact media processor 10 is shown located inside of an entry gate housing 12, which utilizes a rotating bar 14. The entry gate housing 12 includes a display 16 to communicate with the user information, such as that the token inserted into the media processor 10 does not have sufficient value associated with the token to allow entrance to the area beyond the turnstile gate. The tokens are inserted into an entry, such as a token entry bezel 18 that is typically part of the media processor 10. The media processor 10 processes the token and, accordingly, determines the exit path for the token from the media processor 10. For example, in the example shown, the token would take one of three exit paths from the media processor 10 to either a first capture bin 22, a second capture bin 20, or to a rejection tray 24. The rejection tray 24 allows the user to reclaim the token since the token was not captured inside of either the first bin 22 or the second bin 20.

The media processor also may be used in a vending machine mode, and as shown in FIG. 1B, the media processor 10 is incorporated into a vending machine 26, wherein a token supply hopper 28 provides a supply of tokens to the media processor 10. The media processor 10 writes the appropriate value onto the tokens according to the amount of money and instructions provided by the user. The tokens are dispensed either to a token issue tray 30 or to a rejection bin 32. The vending machine 26 further includes a means to communicate with the user, such as by a display 34 or the like. The vending machine 26 further includes a coin acceptor 36 so that the user may insert the appropriate coin into the vending machine 26.

The media processor 10 also may be utilized in an encoder/sorter mode. FIG. 1C illustrates the media processor 10 incorporated into an encoder/sorter 38. The encoder/sorter 38 includes a token supply hopper 40 with a transitional singulation unit 42, which supplies one token at a time to the media processor 10. In this mode, the tokens either have no value written on them and while they are processed in the media processor 10, they are encoded with a value and then sorted into either a first bin 44, a second bin 46, or a third bin 48, which may be a rejection bin. In the alternative, in this mode, tokens that have been used and collected from the turnstile gate 12 may be sorted by the media processor 10, wherein the tokens may have a variety of token types and, for example, tokens of a first type are stored in the first bin 44, and tokens of a second type are stored in the second bin 46, and tokens of a third type are stored in the third bin 48.

The media processor 10 also may be utilized in a token booth mode, and as shown in FIG. 1D, the token processor is incorporated into a token booth table top arrangement 50. The token booth configuration includes a mini hopper 52, which may allow for a relatively small amount of tokens to be stored in the hopper 52 or may further accommodate a single token at a time to be inserted into the hopper 52. The hopper 52 provides the supply of tokens to the media processor 10, which encodes a value to the token based upon the desired purchase amount by the consumer. The tokens, after being encoded in the media processor 10, are dispensed to an issue cup 54 or in the alternative to a rejection bin or container 56. In the token mode, the token booth 50 may be situated on top of a table top or counter inside of a token booth so that the token operator has easy access to the token processor 50.

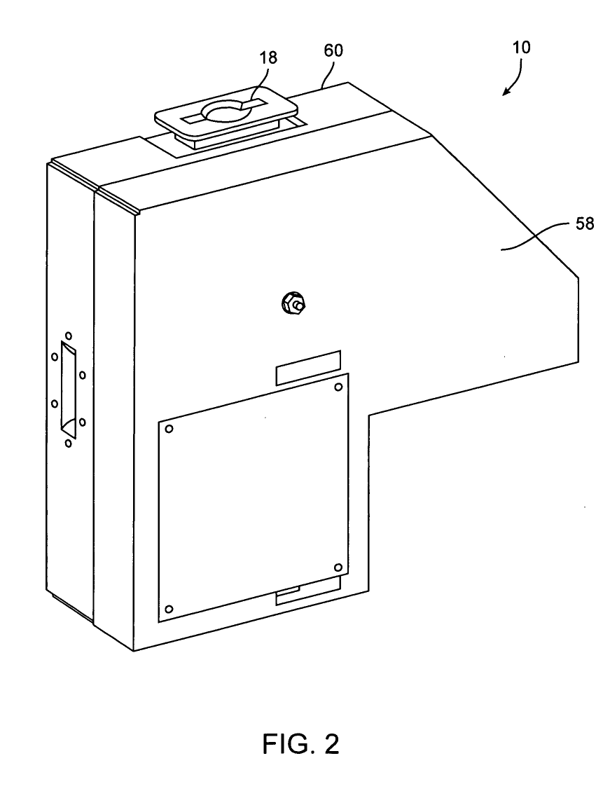

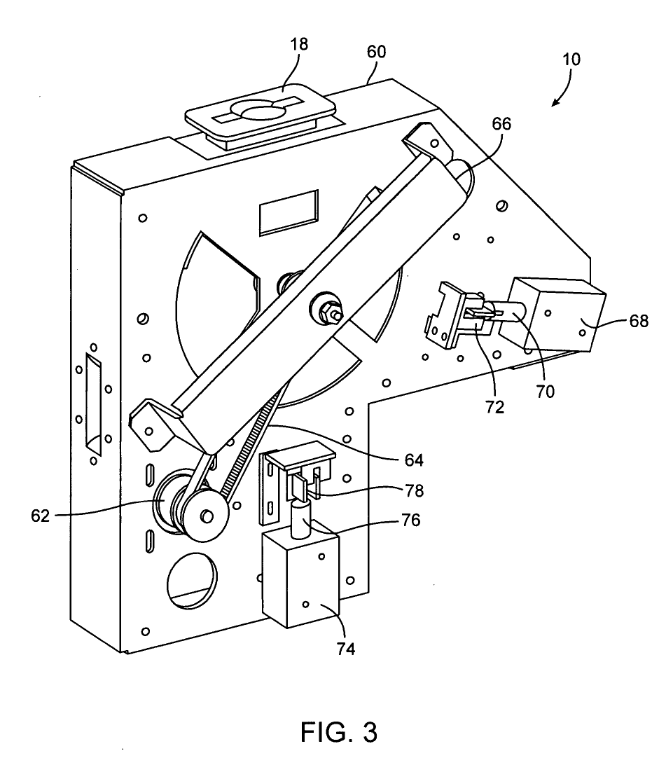

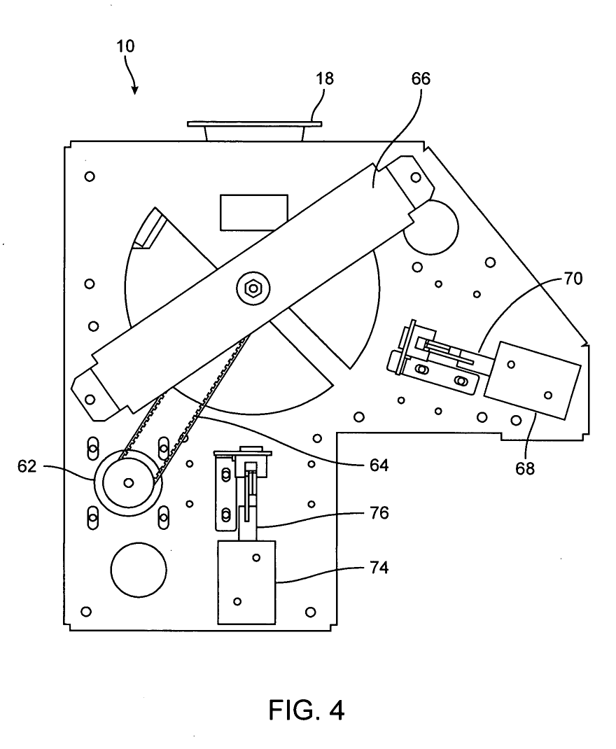

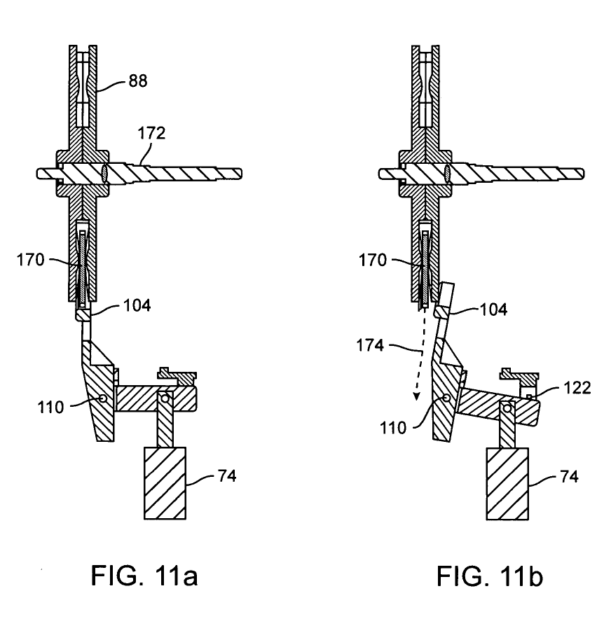

As shown in FIG. 2, the media processor 10 includes a first cover 58 and a second cover 60 to protect electronics and working mechanisms inside of the media processor and further to provide structure for the media processor to be secured inside one of the housings as required by the desired mode of operation. The media processor 10 further includes a token entry bezel 18, which will be further described below. FIGS. 3 and 4 illustrate the media processor 10 with the first cover 58 shown removed. The media processor 10 includes a motor 62 which provides power to a belt 64 for moving tokens through the media processor. A support bar 66 provides support to a shaft that extends through a rotating disk, both of which are shown in more detail in FIG. 11. The media processor 10 further includes a first blocker actuator 68 which actuates a first actuator piston 70 which is connected to a first actuator linkage 72, which applies pressure to a first blocker, which is further described below. The media processor further includes a second blocker actuator 74 which actuates a second actuator piston 76, which is attached to a second actuator linkage 78, which is connected to a second blocker, which will be further described below.

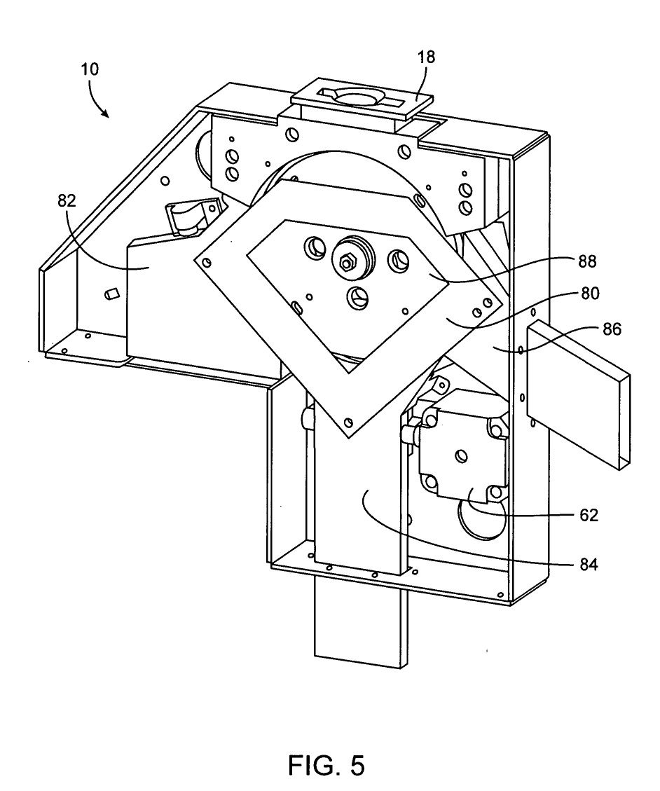

FIG. 5 illustrates the media processor 10 with the second cover 60 shown removed. A sensor PCB 80 is shown, and underneath is a first pathway chute 82, a second pathway chute 84, and a third pathway chute 86. Also shown in FIG. 5 is a rotating disk 88 which provides a means for moving tokens from the entry bezel 18 to the appropriate pathway chute.

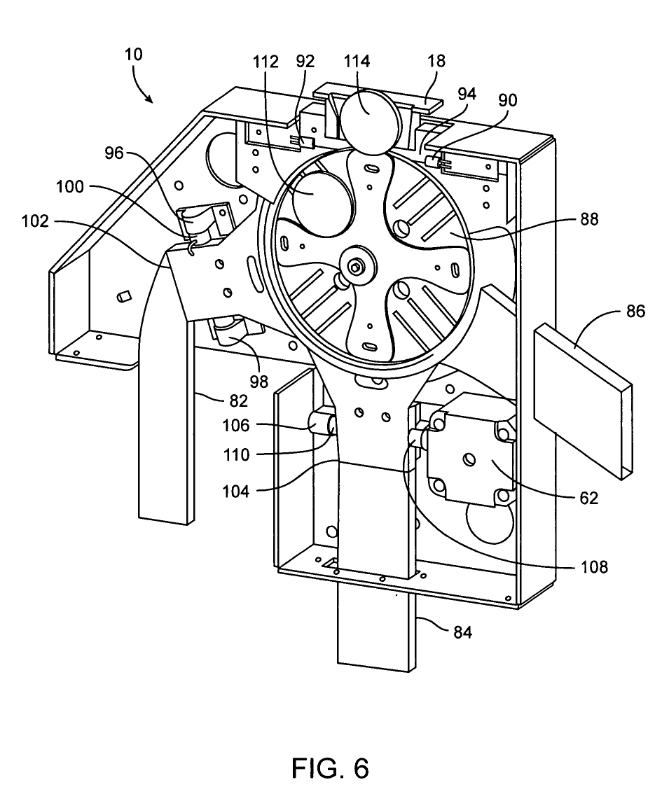

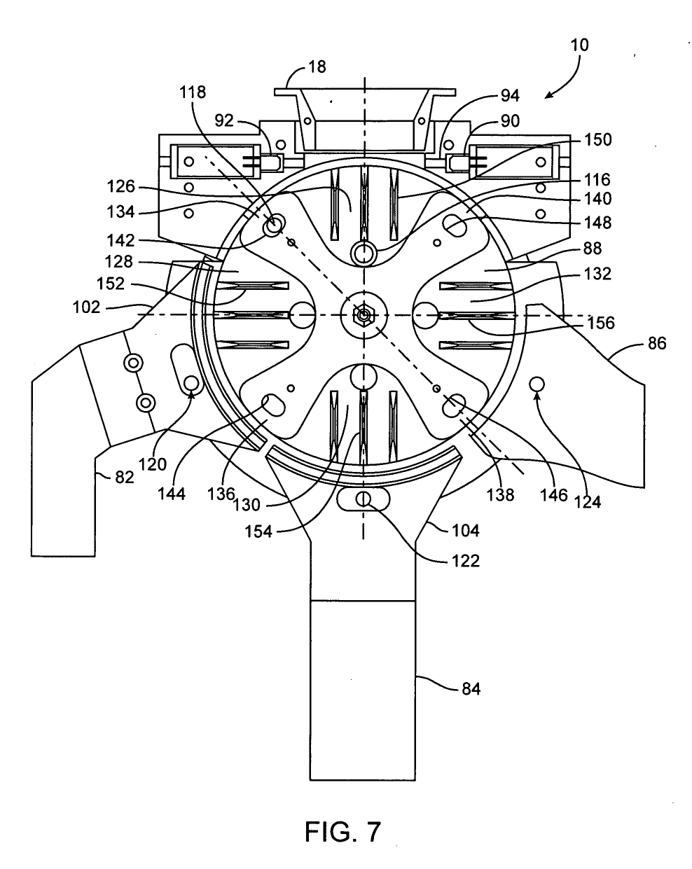

FIG. 6 and FIG. 7 both illustrate a cross-sectional view of the media processor 10 with the second cover 60 shown removed and with half of the rotating disk 88 shown removed, and further with the first pathway chute 82, the second pathway chute 84, and the third pathway chute 86, shown partially removed. The media processor 10 includes a plurality of sensors which sense the presence of a token within the media processor 10, and more specifically, the location of a token or tokens within the media processor. For example, the media processor 10 includes an entry bezel sensor transmitter 90 and an entry bezel sensor receiver 92. The entry bezel sensor transmitter 90 and sensor receiver 92 communicate with each other to sense the presence of a token being inserted into the media processor by the token exiting the entry bezel 18 and entering into receptacles within the rotating disk 88. In order for the entry bezel sensor transmitter 90 and the entry bezel sensor receiver 92 to communicate with each other, the media processor further includes an entry bezel sensor pathway 94 which allows for the communication between the sensor transmitter 90 and the sensor receiver 92.

The media processor 10 further includes a first support 96 for a first blocker pivot rod 100, and an opposite second support 98 for the first blocker pivot rod 100. The first blocker pivot rod 100 is attached to a first blocker 102. Likewise, a second blocker 104 is connected to a second blocker pivot rod 110, which is supported by a first support 106 for the second blocker pivot rod 110 and a second support 108 for the second blocker pivot rod 110. The blockers are typically in a closed position blocking the pathways in the pathway chutes 82 and 84 from the receptacles for the tokens in the rotating disk 88. The first blocker 102 and the second blocker 104 are actuated by the first blocker actuator 68 and the second blocker actuator 74, respectively. When the blockers 102 and 104 are actuated, they move from a closed position to an opened position so that tokens may fall down a determined pathway based on the processing of the token.

As shown in FIG. 6, the first token medium 112 has been received in a receptacle within the rotating disk 88 and has been accepted from the entry bezel 18 and rotated counterclockwise from the entry bezel 18 to a media processing location located roughly at the 10 o'clock position, as shown in FIG. 6. The medium 112 is processed by utilizing an antenna (not shown in FIG. 6) according to ISO standard 14443 type B. Other applicable standards may include ISO/IEC 14443-2—Radio Frequency Power and Signal Interface, ISO/IEC 14443-3—Initialization and Anti-Collision, and ISO/IEC 14443-4—Transmission Protocol. Also as shown in FIG. 6, when a first medium 112 is being processed in the media processor, particularly when the medium is being processed at the 10 o'clock position as shown in FIG. 6, a second medium 114 is located in the entry bezel 18 and is blocked by a rib in the rotating disk 88 from entering into the rotating disk 88. However, when medium 112 is finished being processed and the rotating disk 88 further rotates counterclockwise as shown in FIG. 6, medium 114 is in position to drop into the next receptacle within the rotating disk 88 and is ready to be processed. In this example, the media processor 10 allows the processing of media, or more than one medium, at one time.

FIG. 7 further illustrates details about the media processor 10 and more particularly the rotating disk 88. The rotating disk further includes a plurality of sensors and sensor passageways to determine whether tokens have been received within the receptacles of the rotating disk. The rotating disk includes a token sensor 116, which senses the presence of a token in the receptacle which is directly below the entry bezel 18. Further, the media processor 10 includes a disk positioning sensor 118 which senses whether the rotating disk 88 is in the proper orientation to accept a token from the entry bezel 18. Further, the media processor 10 includes a first pathway sensor 120 which senses the passing of a token from that rotating disk 88 into the first pathway chute 82. The media processor 10 further includes a second pathway sensor 122 which senses the passing of a token from the rotating disk 88 into the second pathway chute 84. The media processor further includes a third pathway sensor 124 which senses the passing of a token from rotating disk 88 to the third pathway chute 86. It should be noted that the media processor 10 includes, in the example shown, two blockers, the first blocker 102 and the second blocker 104, even though there are three exit pathways defined by the first pathway chute 82, the second pathway chute 84, and the third pathway chute 86. The token will exit the rotating disk 88 into the first pathway chute 82 if the first blocker 102 is open, which allows for a path from the rotating disk 88 to the first pathway chute 82. In contrast, the token will exit the rotating disk 88 into the second pathway chute 84 if the first blocker 102 is in the closed position and if the second blocker 104 is in the open position. In contrast, the token will exit the rotating disk 88 if the first blocker 102 and the second blocker 104 are in the closed positions and, therefore, the token then will exit the rotating disk 88 into the third pathway chute 86 by default.

The media processor further includes a first token receptacle 126, shown generally at the 12 o'clock position as shown in FIG. 7, in the rotating disk 88. The rotating disk further includes a second token receptacle 128, shown generally at the 9 o'clock position as shown in FIG. 7. The rotating disk further includes a third token receptacle 130 generally shown at the 6 o'clock position in FIG. 7, and the rotating disk further includes a fourth token receptacle 132, generally shown at the 3 o'clock position as shown in FIG. 7. The rotating disk further includes a plurality of spacers that space apart the sides of the rotating disk which provide for the token receptacles 126, 128, 130, and 132. The spacers shown in a “X” configuration wherein the first rib 134 is shown located generally at a 45 degrees counterclockwise position located from the 12 o'clock position as shown in FIG. 7. Further, the rotating disk includes a second rib 136 located generally at a position 45 degrees clockwise from the 6 o'clock position as shown in FIG. 7. Further, a third rib 138 is shown generally at a 45 degree counterclockwise position from the 6 o'clock position as shown in FIG. 7, and further a fourth rib 140 is shown generally at a 45 degree clockwise position from the 12 o'clock position as shown in FIG. 7. As explained above, and as shown in FIG. 6, the ribs block the passage from the entry bezel so that when a token is being processed or being written to, read from, validated, overwritten to, or otherwise processed by the antenna in the media processor 10, the ribs prevent a second token from moving from the entry bezel 18 into the rotating disk 88, although the second token, as shown in FIG. 6, is still located within the media processor 10 by resting within the entry bezel 18.

Each rib includes an aperture to allow for the disk positioning sensor 118 to operate, since the disk operating sensor has a transmitter and a receiver similar to the entry bezel sensor 90 and 92. Therefore, as shown in FIG. 7, rib 134 includes a first rib aperture 142. Likewise, the second rib 136 includes a second rib aperture 144, and the third rib 138 includes a third rib aperture 146, and the fourth rib 140 includes a fourth rib aperture 148.

The token receptacles and the rotating disk 88 further include grooves or indentations in each receptacle area to eliminate the Token from sticking to the side of the receptacle. The first token receptacle 126 includes a first set of indentations 150, likewise the second token receptacle 128 includes a set of indentations 152, and the third receptacle area 130 includes a set of indentations 154. Likewise, the fourth receptacle area 132 includes a set of indentations 156.

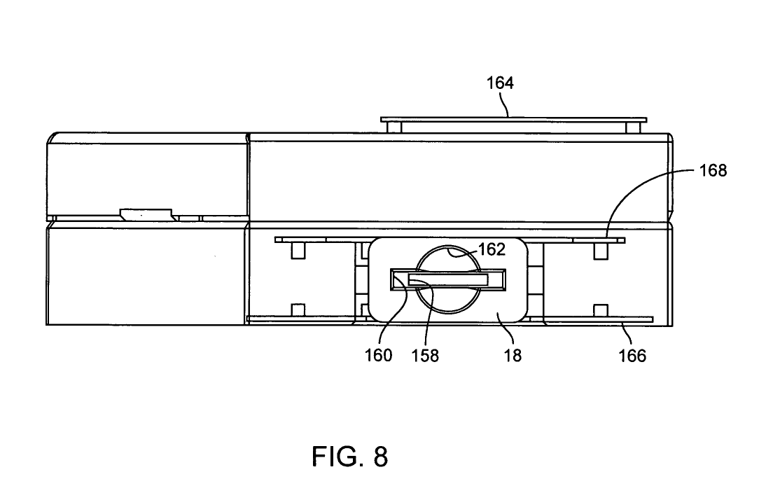

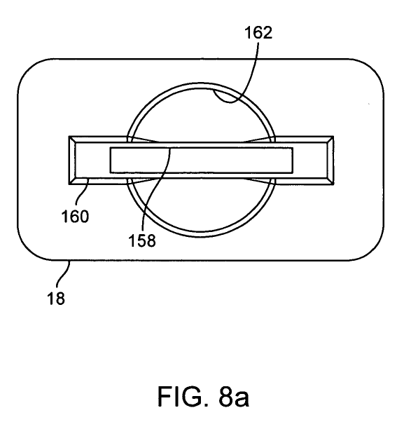

FIG. 8 and FIG. 8A provide further detail on the entry bezel 18. As shown in FIG. 8, the entry bezel includes an entry bezel opening 158 which is generally rectangular in configuration to allow for the acceptance of a token into the rotating disk 88. The entry bezel further includes a flared opening 160 which allows for an imprecise positioning of the token by the user and so that the token is funneled into the entry bezel opening 158. Further, as shown in the figures, the entry bezel further includes an entry bezel opening extension 162 which allows for the user to place an opposing finger and, for example, the user's thumb into the entry bezel opening extension 162 to allow for the placement of the token into the entry bezel opening 158, or in the alternative, to retrieve the token if a rib of the rotating disk is positioned at the 12 o'clock position preventing the token from being inserted into the rotating disk 88.

As further shown in FIG. 8, the media processor 10 includes a control board 164 to control the operations and processing of the tokens in the media processor 10. The control board may be an eight bit microprocessor, or equivalent, such as PN Intel 8051, or any equivalent microprocessor. The media processor 10 further includes a transmission sensor board 166 to control the transmission of the transmitting sensors, and likewise the media processor 10 further includes an antenna/receiving sensor board 168 which controls the receiving sensors in the media processor 10.

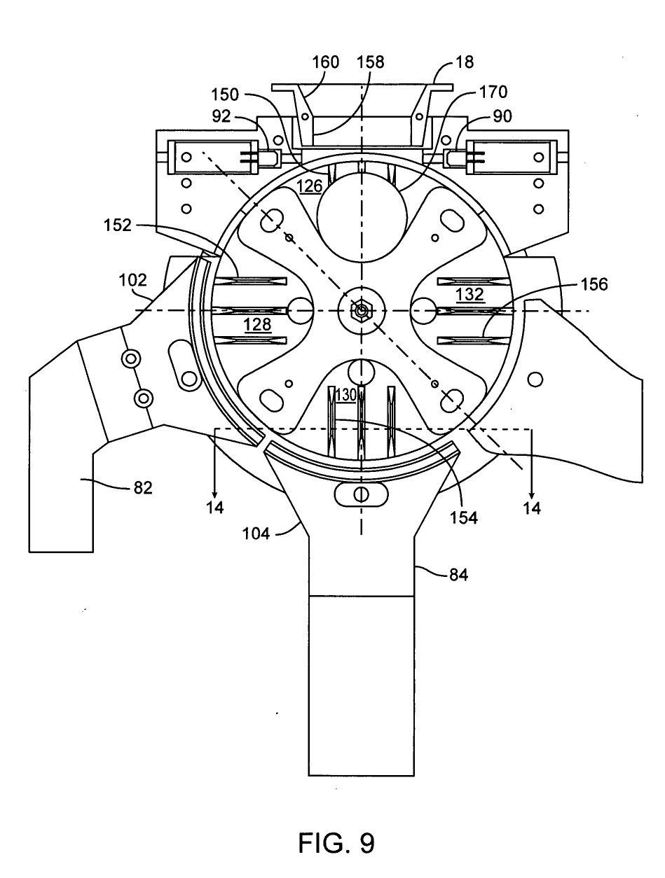

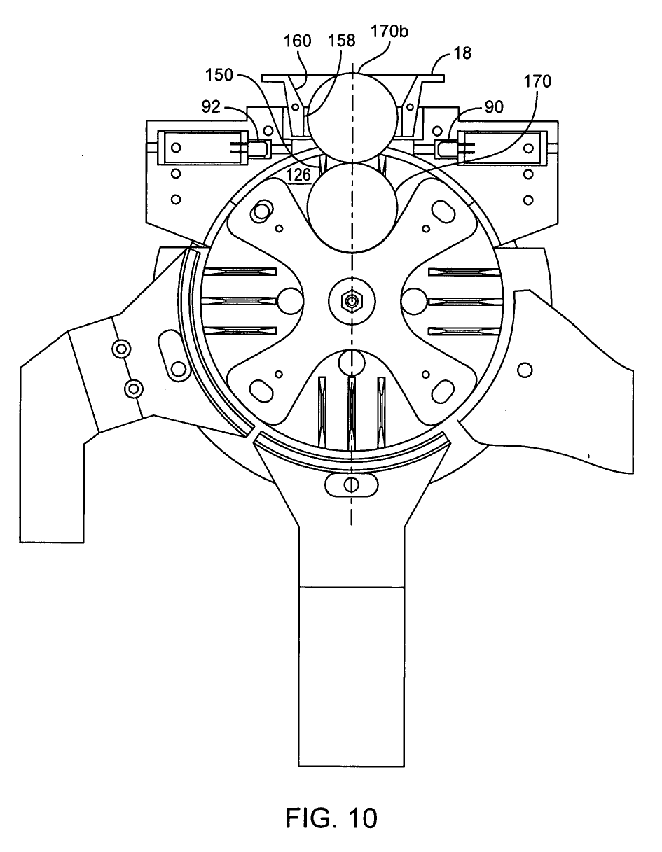

FIG. 9 illustrates a token or medium 170 which has been inserted into the entry bezel 18 and the token 170 has passed through the entry bezel opening 158 and come to a rest in the first token receptacle 126. FIG. 10 illustrates that the configuration of the rotating disk 88 and the ribs and first token receptacle 126 are configured so that when a second token 170b is inserted into the entry bezel 158 it is not advanced from the entry bezel 18 into the rotating disk, nor is the second token 170b capable of falling into the rotating disk until the rotating disk 88 is rotated to a position wherein a token receptacle that does not house a token is located directly underneath the second token 170b.

FIG. 11 illustrates a side cross-sectional view of the rotating disk and the second blocker 104. FIG. 11A illustrates the blocker 104 in the closed position trapping token 170 in the rotating disk. FIG. 11B illustrates the second blocker 104 in the open position, wherein actuator 74 has been actuated to retract an arm extending from the blocker 104 so that the blocker pivots about the second blocker pivot rod 110 and thereby allowing the token 170 to be free to fall from the rotating disk into the appropriate passageway, and in this situation a token would fall into the second pathway chute 84. The token is free to fall from the rotating disk along pathway 174, which in this case would be the second pathway chute 84. The second blocker sensor 122 senses whether the second blocker 104 is in the open or closed position since the blocker sensor 122 is blocked when the blocker is in the closed position, where the blocker sensor is clear when the blocker 104 is in the open position.

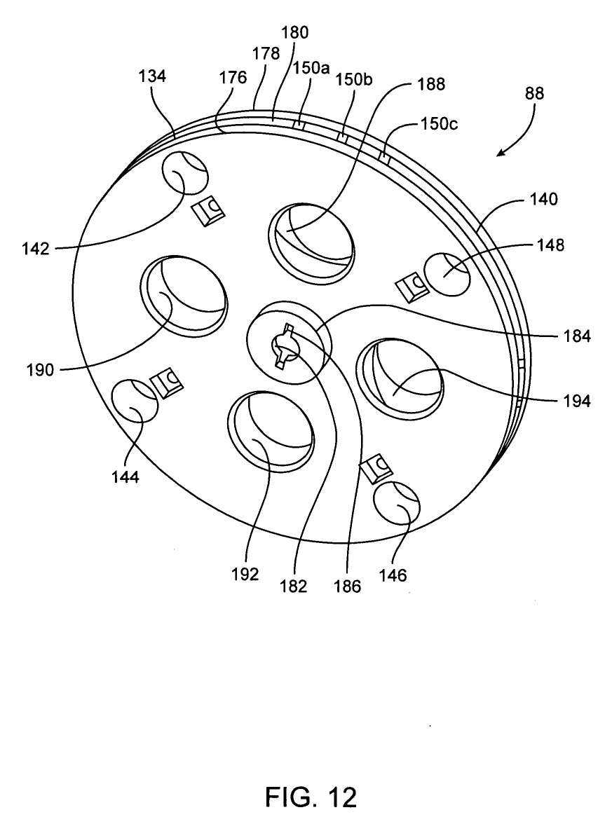

As also shown in FIG. 11, the rotating disk 88 rotates about a disk shaft 172. As shown in FIG. 12, the rotating disk 88 includes a rotating disk first side 176 and an opposite rotating disk second side 178, defining a space 180 between the disk sides. Rotating disk 88 includes a shaft opening 182 for accepting the disk shaft 172. The shaft opening 182 extends through a bushing 184, with a keyway 186. The space between the disk sides 188 are divided by the ribs 134, 136, 138, and 140, as described above. The rotating disk 88 further includes apertures that allow for the sensors to detect the position of the rotating disk 88 and the media processor 10, and further to determine the presence of a token in the rotating disk 88. Therefore, the rotating disk 88 includes a first rotating disk aperture 188, a second rotating disk aperture 190, a third rotating disk aperture 192, and a fourth rotating disk aperture 194. The rotating disk apertures 188, 190, 192, and 194 allow for the token receptacle sensor 116 to operate since the sensor includes a transmission sensor and a receiving sensor, as described above.

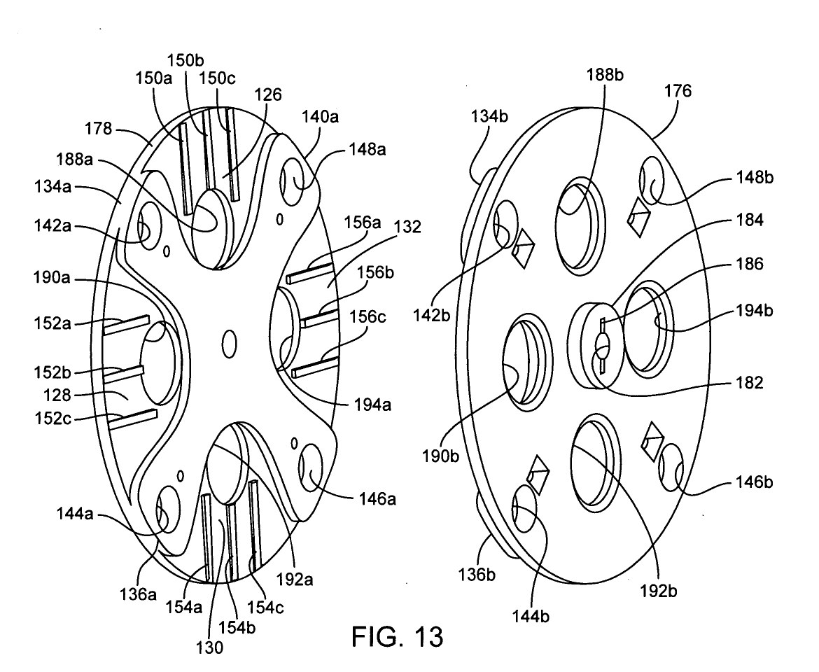

FIG. 13 illustrates an exploded perspective view of the rotating disk of the media processor 10, wherein the disk sides 176 and 178 are shown separated, and the elements are labeled with corresponding reference numerals with the rotating disk first side 176 having a “b” annotation after each reference numeral, and the rotating disk second side 178 includes corresponding reference numerals with a “a” annotation.

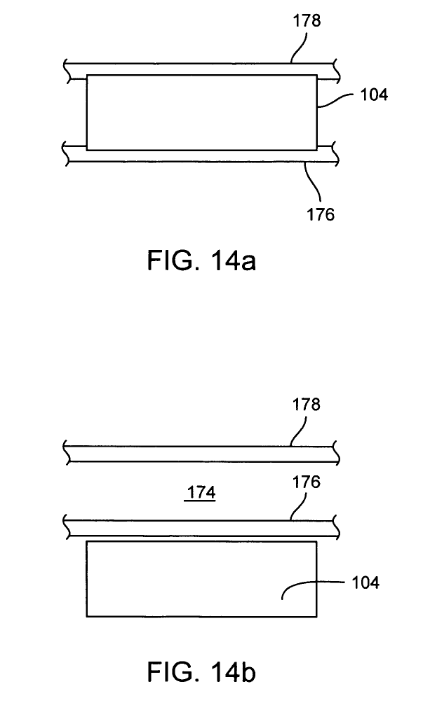

FIG. 14 illustrates the cross-sectional view taken from line 14-14 of FIG. 9, where it is shown FIG. 14A that the second pathway chute 84 is blocked when the second blocker 104 is in the closed position therefore not allowing the token to fall from the rotating disk 88. As shown in FIG. 14B, the second pathway 84 is shown exposed to the rotating disk 88 since the second blocker 104 is shown in the open position, allowing the token to fall from the rotating disk 88 into the second pathway chute 84.

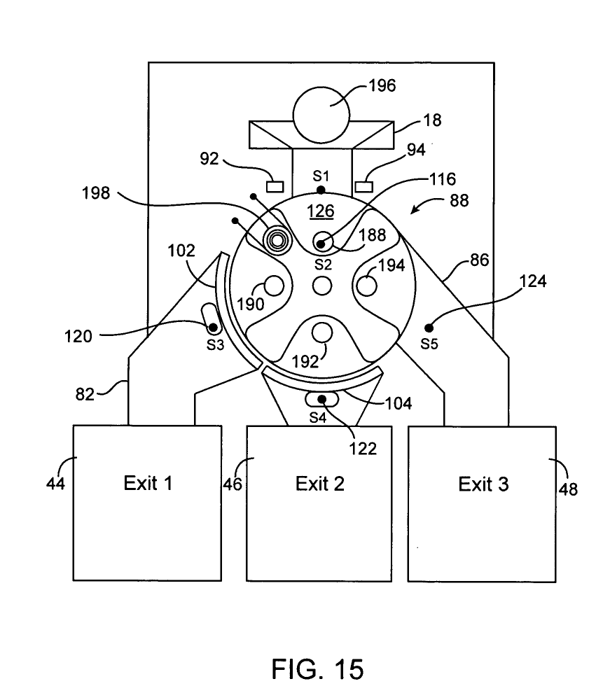

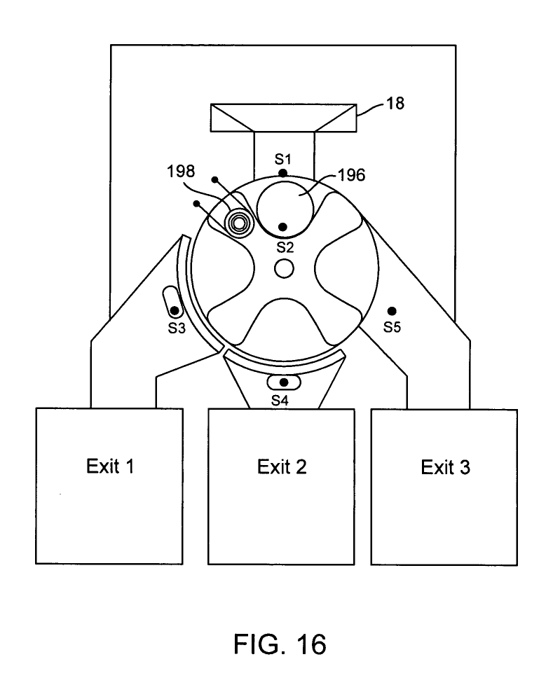

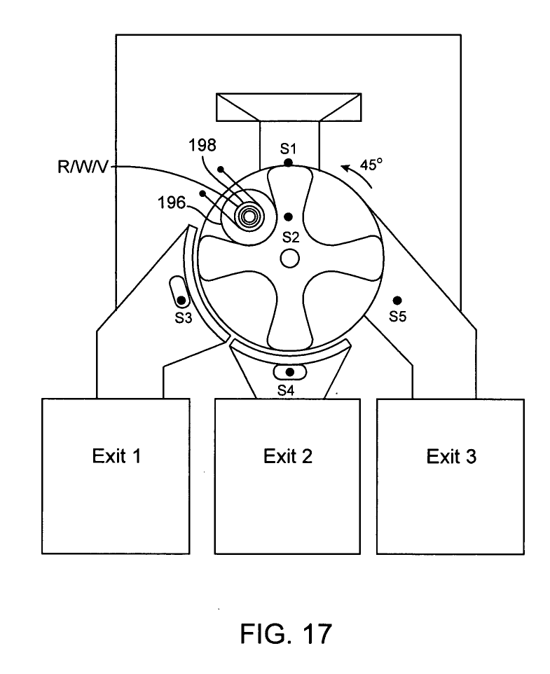

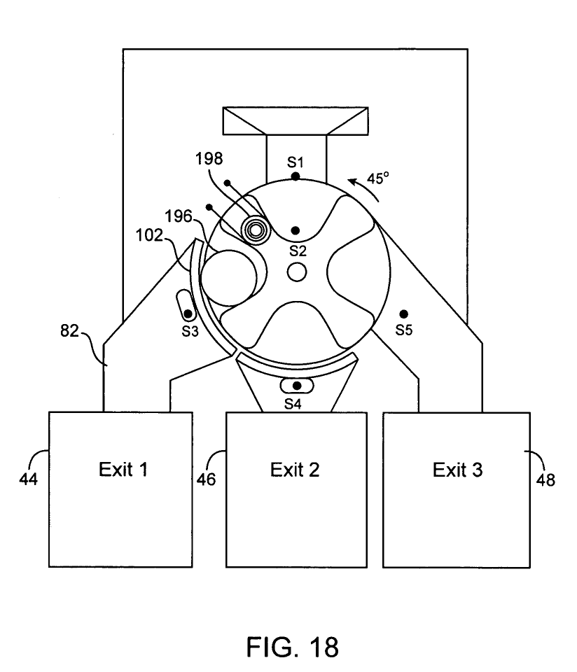

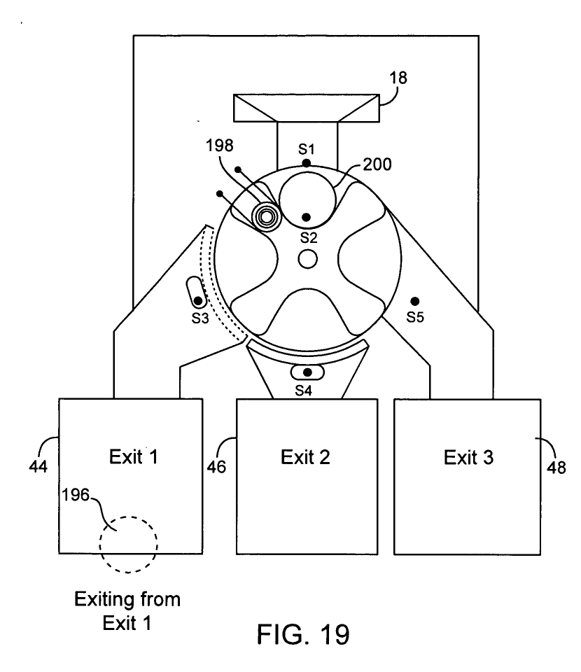

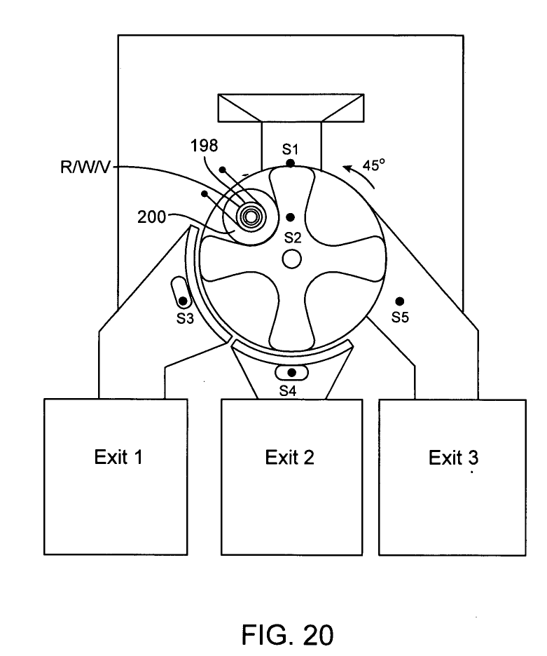

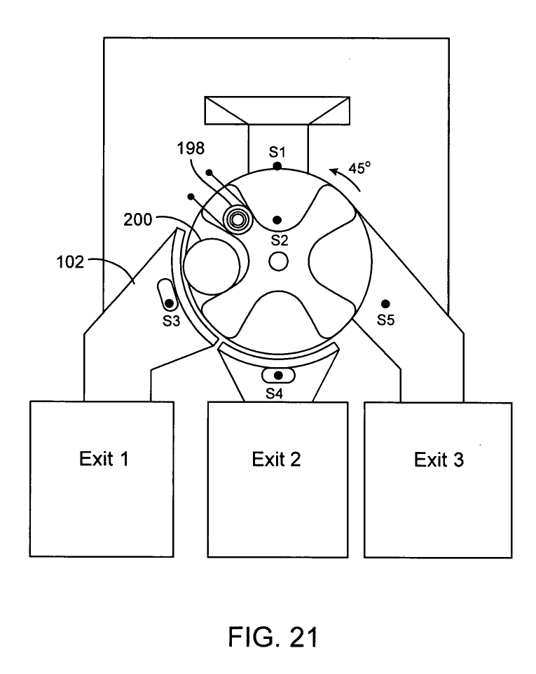

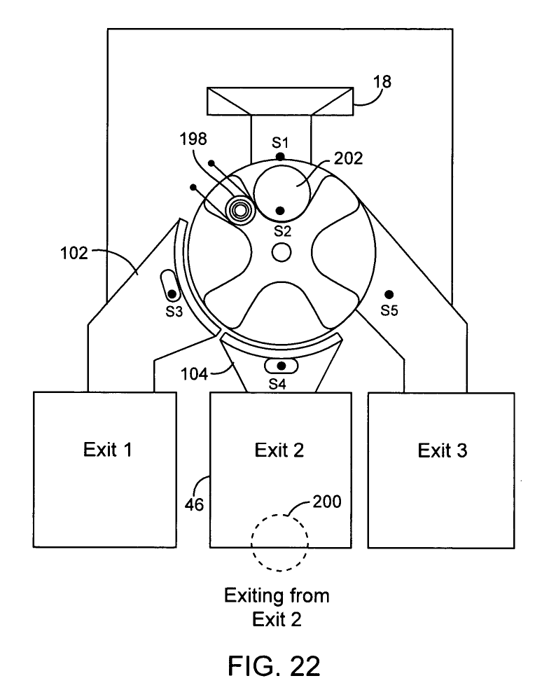

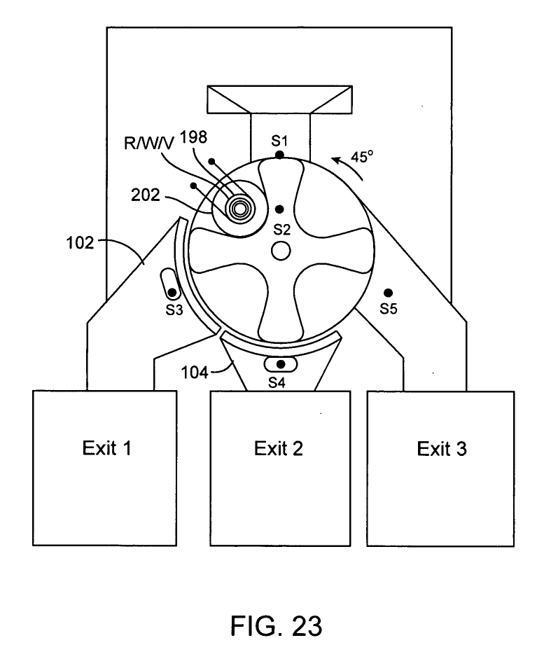

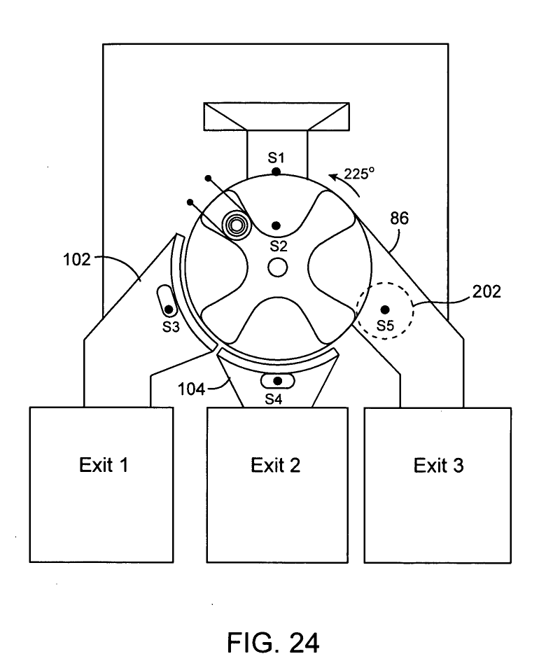

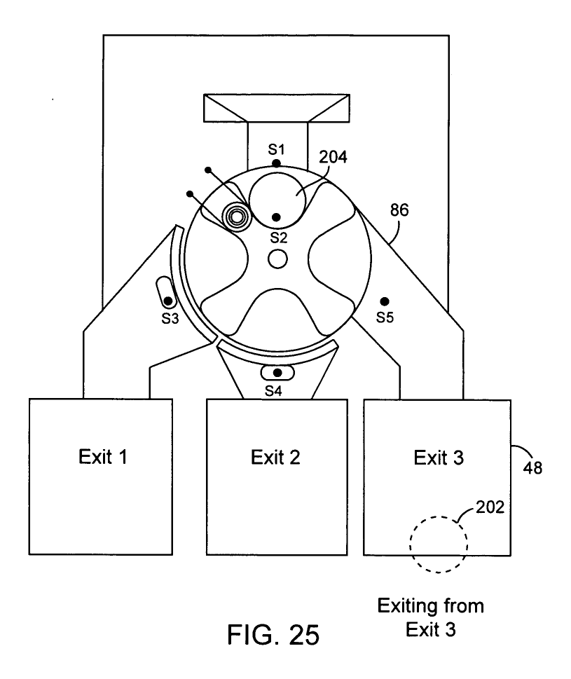

FIGS. 15-25 illustrate the operation of the media processor when the media processor 10 is in the encoder or sorter mode. As shown in FIG. 15, a token 196 is shown being inserted into the entry bezel 18. FIG. 16 illustrates the token 196 resting in the first rotating disk receptacle 126, with the token 196 blocking the receptacle sensor pathway, defined by the first rotating disk aperture 188. FIG. 17 illustrates the rotating disk 88 rotating approximately 45 degrees counterclockwise so that the token 196 is located proximate to the antenna 198, so that the token may be written to, verified or validated, or read from and processed. FIG. 18 illustrates the rotating disk 88 further rotating 45 degrees counterclockwise so that the token 196 is located adjacent to the first blocker 102. In this example, the first blocker 102 is in a closed position and, therefore, the token 196 does not exit into the first pathway chute 82 until, as shown in FIG. 19, the blocker 102 is moved to the open position and therefore the token 196 exits along the first pathway chute 82 and terminates in the first capture bin 44. As also shown in FIG. 19, another token 200 has been inserted into the entry bezel so that it comes to rest in the second token receptacle 128. FIG. 20 illustrates the rotating disk 88 further rotating counterclockwise 45 degrees so that the token is located adjacent to the antenna 198 so that the token may be processed. FIG. 21 illustrates the rotating disk 88 further rotating 45 degrees counterclockwise so that the token 200 is located adjacent to the first blocker 102. In this example, the first blocker 102 remains in the closed position. As shown in FIG. 22, the rotating disk 88 has further rotated counterclockwise 45 degrees so that token 200 exits the token receptacle 128 into the second capture bin 146 because the second blocker 104 has actuated to be in the open position. Further, as shown in FIG. 22, another token 202 has been inserted into the entry bezel 108 and comes to rest in the token receptacle 132. As shown in FIG. 23, the rotating disk 88 has rotated counterclockwise 45 degrees so that the token 202 is located adjacent to the antenna 198 for processing. As shown in FIG. 24, the rotating disk 88 has been rotated counterclockwise 225 degrees so that token 202 exits the rotating disk by entering the third pathway chute 86. The token 202 exits the third pathway chute 86 since the first blocker 102 and the second blocker 104 remained in the closed positions. FIG. 25 illustrates token 202 being located in the third receptacle 48, which may be for example, a rejection bin. In FIG. 25, an additional token 204 has further been inserted into the entry bezel 18 and is shown at rest in a rotating disk receptacle.

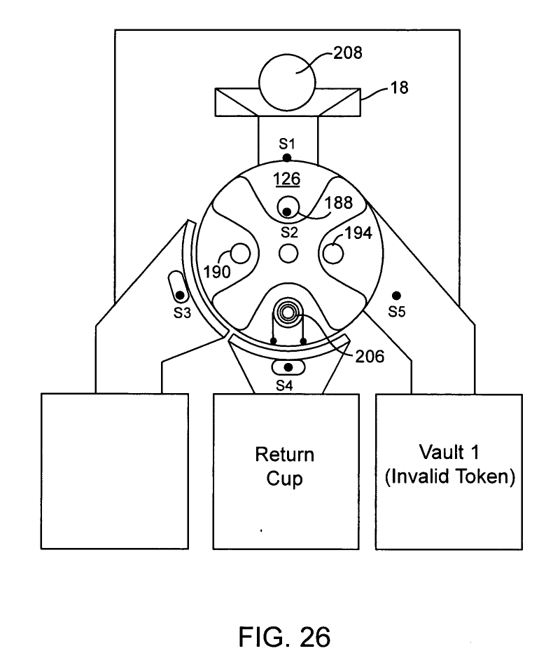

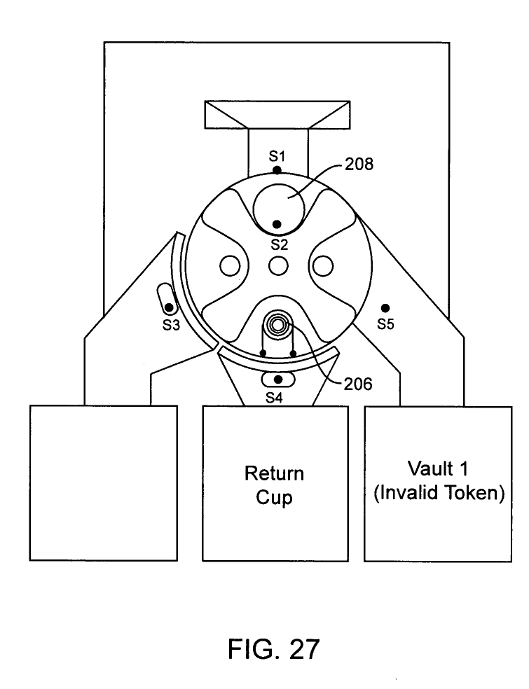

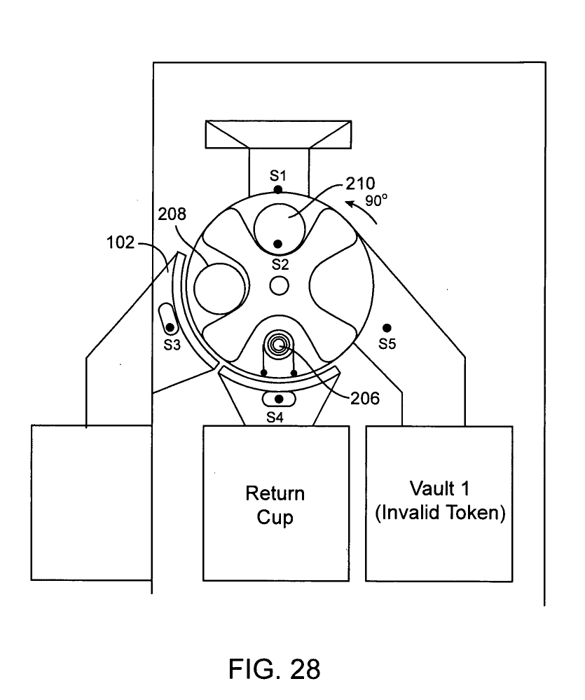

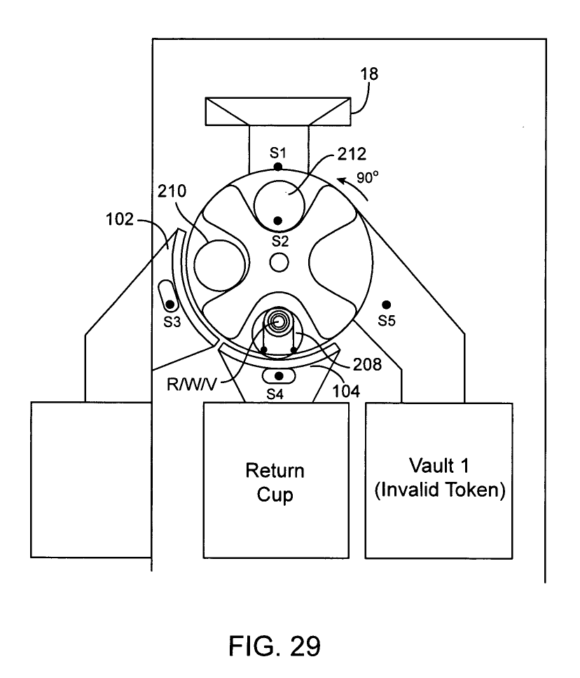

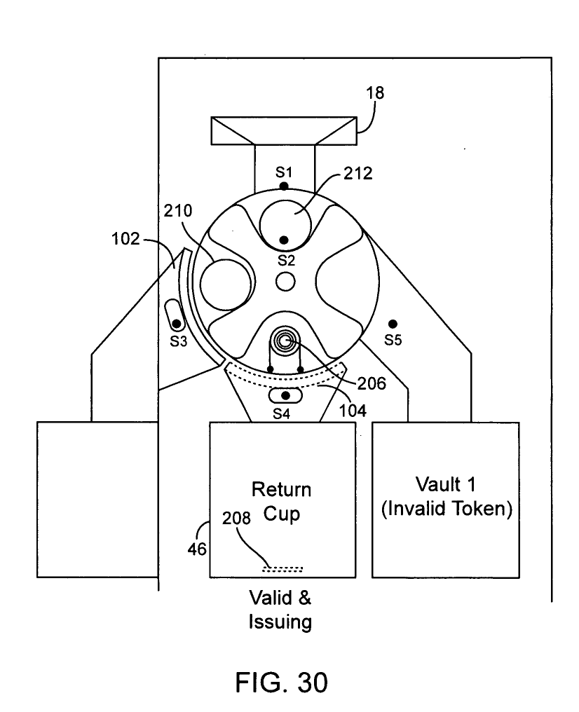

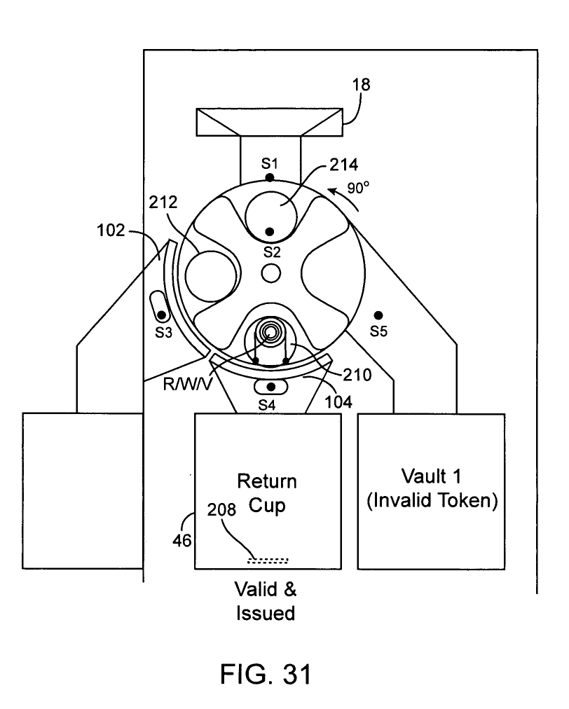

FIGS. 26-31 illustrate the operation of the media processor 10 in the ticket vending machine or the booking office machine mode. In this embodiment, an antenna 206 is located at the 6 o'clock position to allow the escrowed tokens to be issued immediately and to reduce the time that the token may exit the rotating disk 88 to the operator via the second bin 46. In this example, the first bin 44 may not be utilized, and the third bin 48 may be used only for invalid tokens, by way of example only. As shown in FIG. 26, a token 208 is being inserted into the entry bezel 18. FIG. 27 illustrates that the token 208 has come to rest in the rotating disk receptacle. FIG. 28 illustrates the rotating disk being rotated counterclockwise 90 degrees so that the first inserted token 208 is located adjacent to the first blocker 102. In addition, another token 210 has been inserted into the entry bezel and is shown at rest in a rotating disk receptacle. FIG. 29 illustrates that the rotating disk has been rotated counterclockwise another 90 degrees so that the first token 208 is resting adjacent to the antenna 206, with the token 208 being adjacent to the second blocker 104. In addition, the next token 210 is located adjacent to the first blocker 102, and yet another token 212 has been inserted into the entry bezel 18 and is shown at rest in a rotating disk receptacle. FIG. 30 illustrates that the second blocker 104 has been actuated in the open position with the token 208 being dispensed to the second container 46. FIG. 31 illustrates the rotating disk 88 has been rotated counterclockwise another 90 degrees so that token 210 is now located adjacent to antenna 206 and adjacent to the second blocker 104, with the next token 212 being located adjacent to the first blocker 102, and with yet another token 214 having been inserted into the entry bezel and shown at rest in a rotating disk receptacle.

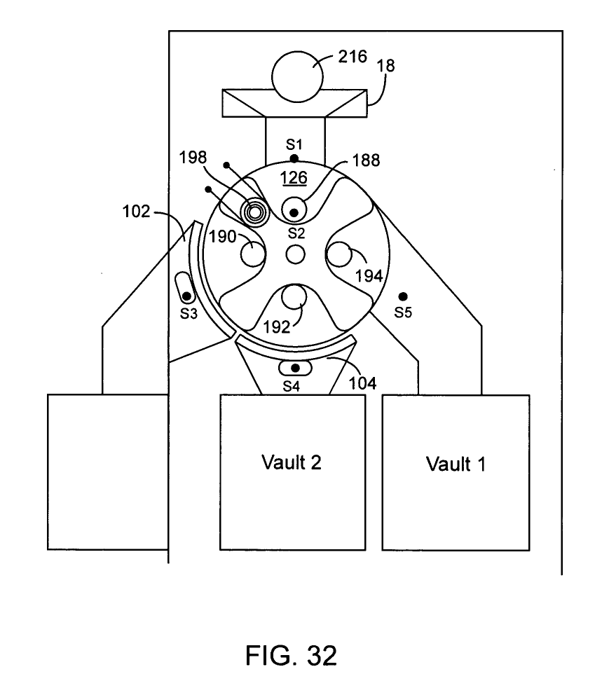

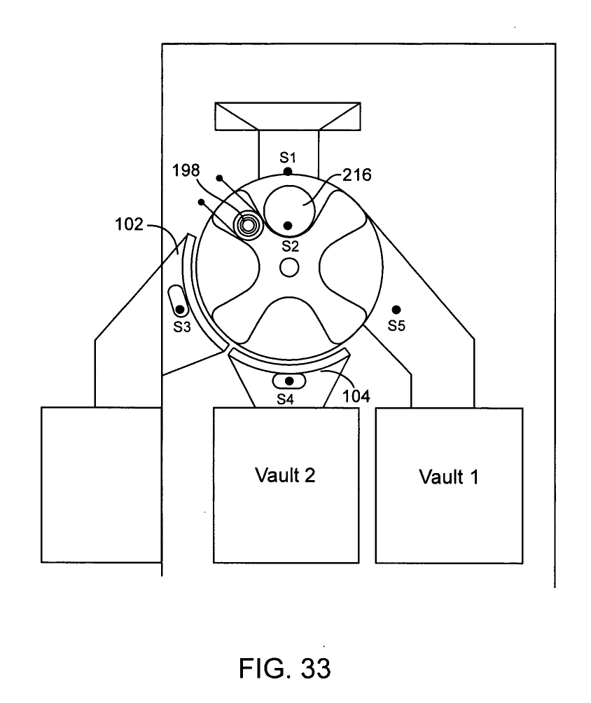

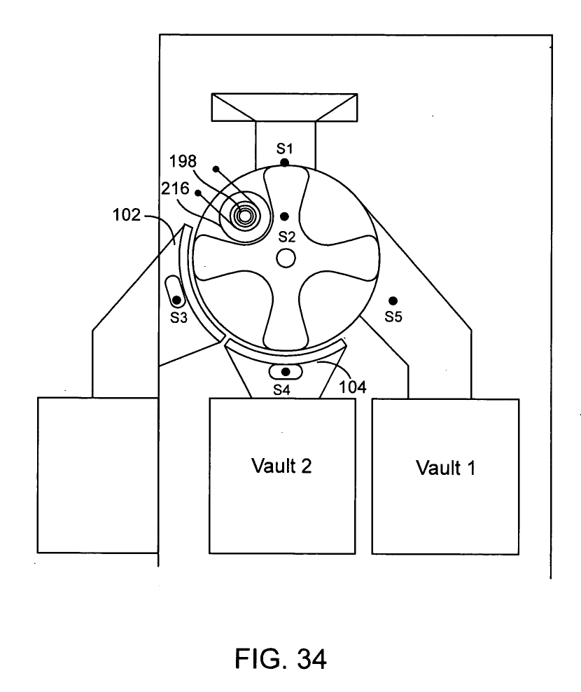

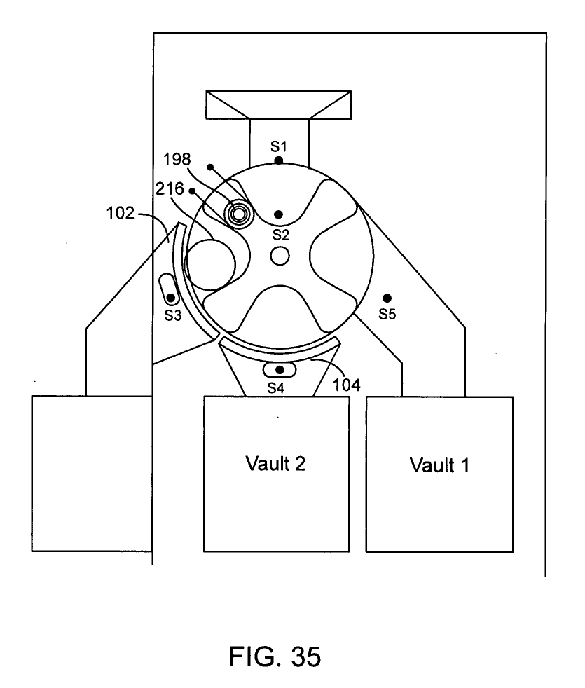

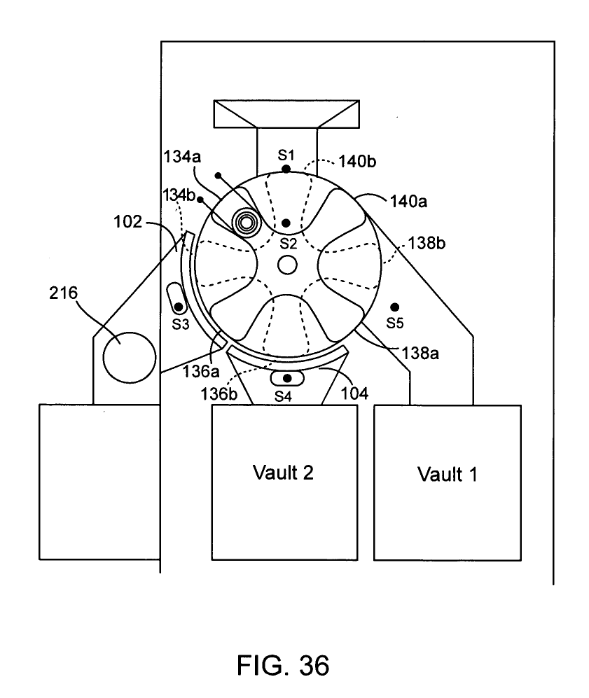

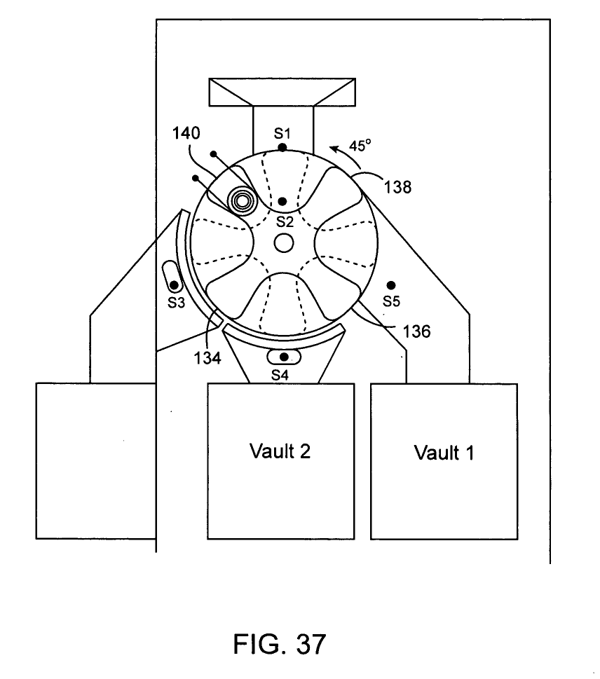

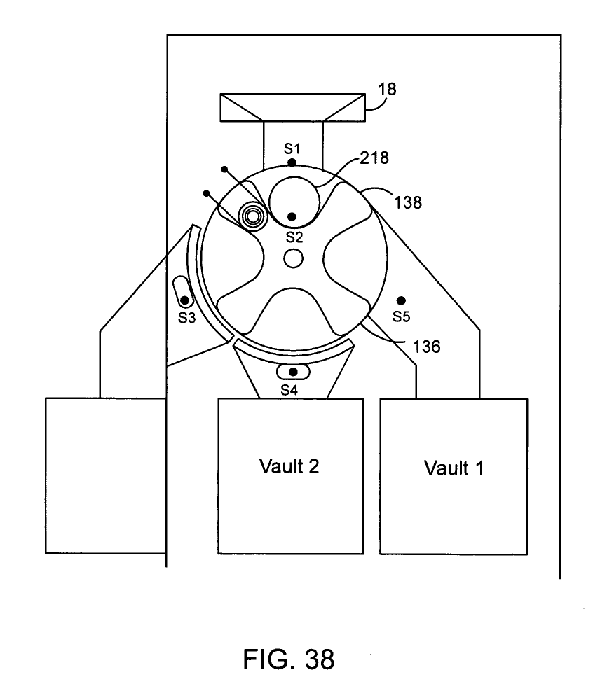

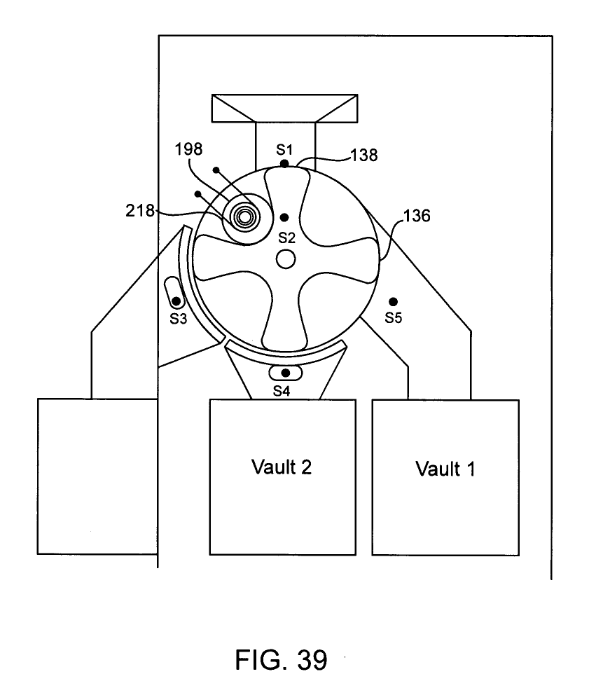

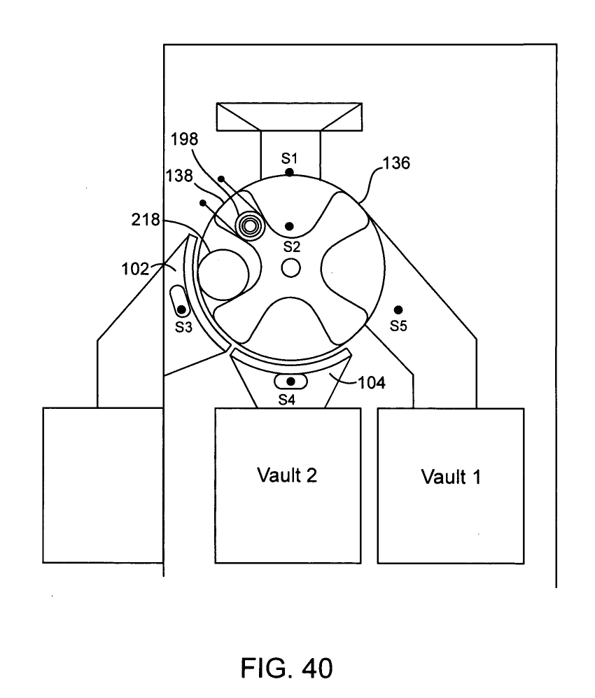

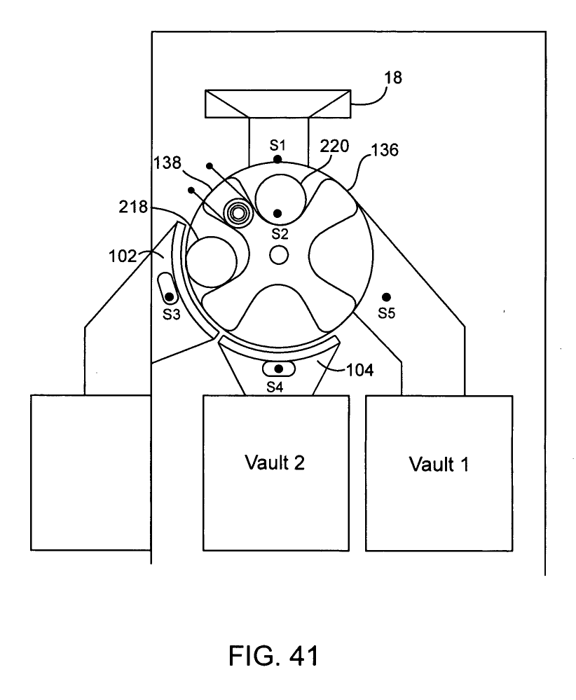

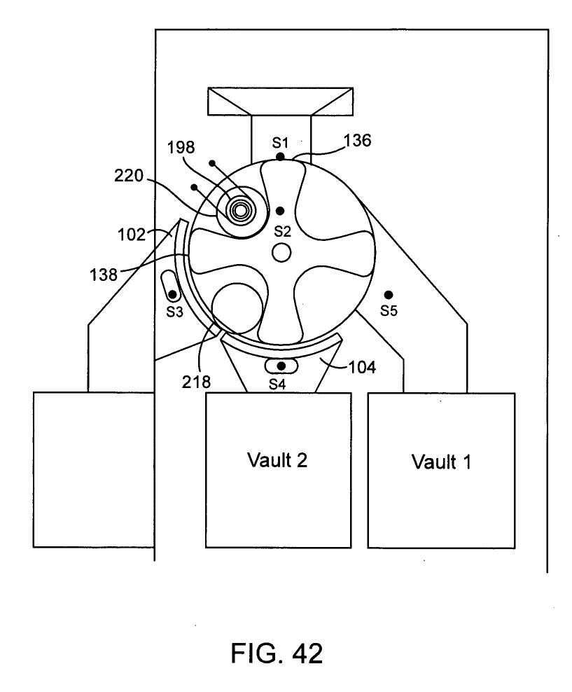

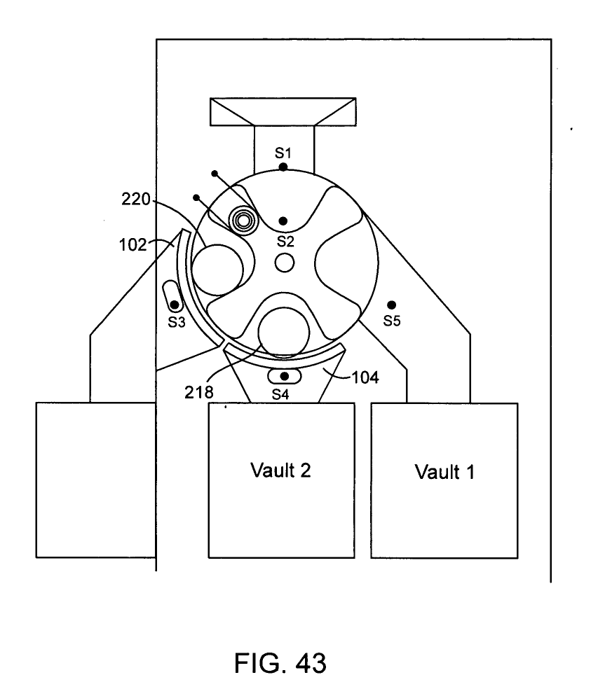

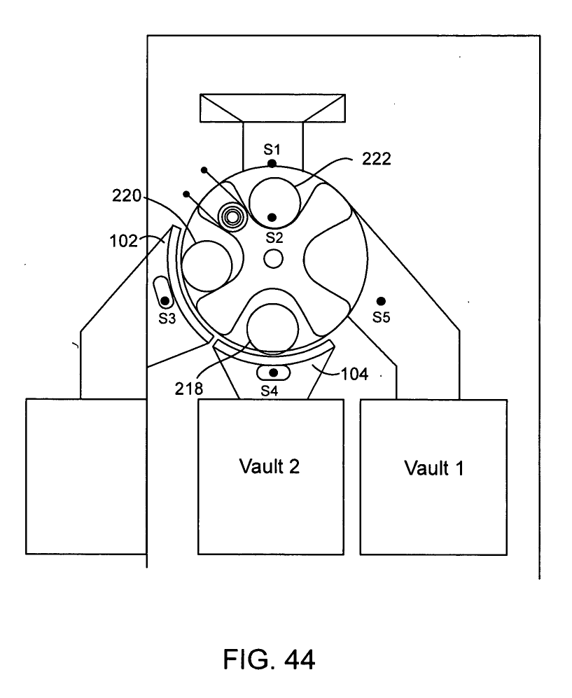

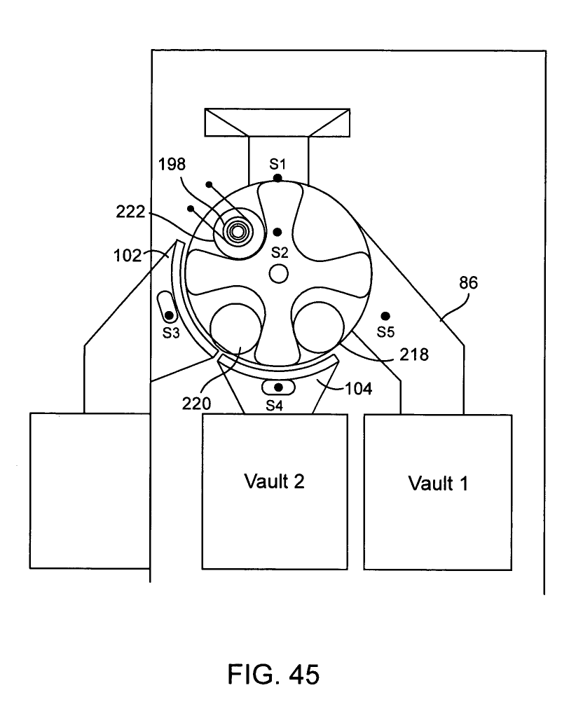

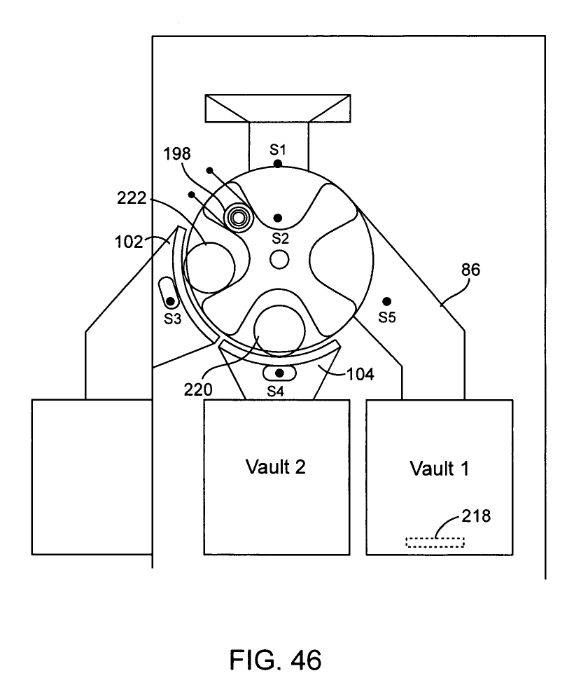

FIGS. 32-46 illustrate the operation of the media processor 10 in the gate entry mode. FIG. 32 illustrates a token 216 being inserted into the entry bezel 18. FIG. 33 illustrates the token 216 shown at rest in a rotating disk receptacle. FIG. 34 illustrates that the rotating disk 88 has been rotated counterclockwise 45 degrees so that the token 216 is adjacent to the antenna 198 so that the token may be read and validated for the appropriate value. FIG. 35 illustrates the rotating disk 88 having been rotated an additional 45 degrees so that the token 216 is located adjacent to the first blocker 102. FIG. 36 illustrates that the blocker 102 has been actuated to be in the open position so that the token 216 exits the rotating disk 88 into the first pathway chute 82. FIG. 36 further illustrates that the rotating disk may provide further momentum to the token to expel the token from the rotating disk if the blocker 102 is in the open position when the rotating disk starts rotating. FIG. 37 illustrates the rotating disk 88 having been rotated to the appropriate position to be ready to accept the next token to be inserted into the entry bezel 18. FIG. 38 illustrates the next token 218 having been inserted into the entry bezel 18, with the token 218 shown at rest in a rotating disk receptacle. FIG. 39 illustrates the rotating disk 88 having been rotated 45 degrees so that the token 218 is located adjacent to the antenna 198. It is further illustrated in FIG. 39 that rotating disk rib 138 is located at the 12 o'clock position to further prevent an additional token to be inserted into the rotating disk 88 while token 218 is being read and validated. FIG. 40 illustrates the rotating disk 88 having been rotated counterclockwise 45 degrees so that the token 218 is located adjacent to the first blocker 102. FIG. 41 illustrates that another token 220 has been inserted into the entry bezel 18 and is shown at rest in a rotating disk receptacle. FIG. 42 illustrates the rotating disk 88 having been rotated counterclockwise an additional 45 degrees so that token 220 is located adjacent to the antenna 198 for reading and verifying, with token 218 being located adjacent to the first blocker 102 and the second blocker 104, with the first blocker 102 and the second blocker 104 being in the closed positions. FIG. 43 illustrates the rotating disk having been rotated counterclockwise an additional 45 degrees so that token 218 is located adjacent to the second blocker 104 and so that token 220 is located adjacent to the first blocker 102. FIG. 44 illustrates an additional token 222 has been inserted into the entry bezel 18 and is shown at rest at a rotating disk receptacle. FIG. 45 illustrates that the rotating disk has been rotated counterclockwise 45 degrees so that token 222 is located adjacent to antenna 198. As also shown in FIG. 45, the media processor 10, as disclosed herein, may process more than one token, or other media, at one time. In the example shown, token 218 is located adjacent to the second blocker 104, token 220 is located adjacent to the second blocker 104 and the first blocker 102, and the third token 222 is located adjacent to antenna 198. As shown in FIG. 46, the rotating disk 88 has been rotated an additional 45 degrees so that token 218 has exited the rotating disk 88 to the third pathway chute 86, and has come to rest in the third bin 48. Token 220 is located adjacent to the second blocker 104, and token 222 is located adjacent to the first blocker 102. Token 218 exited the rotating disk 88 into the third pathway chute 86 since the first blocker 102 and the second blocker 104 remain closed while token 218 was rotated past the first pathway chute 82 and the second pathway chute 84, therefore, token 218 exited the rotating disk 88 along the third pathway chute 86.

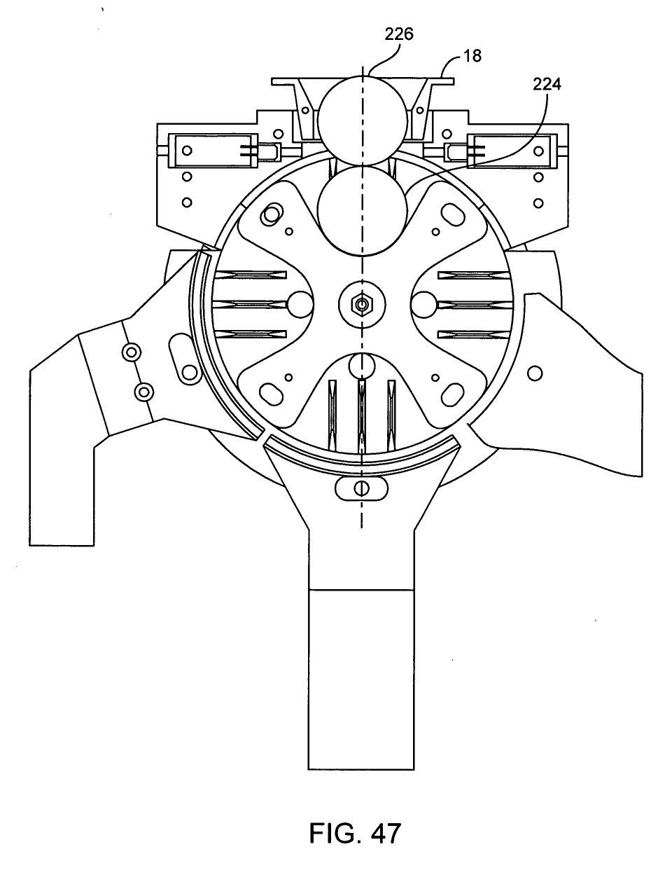

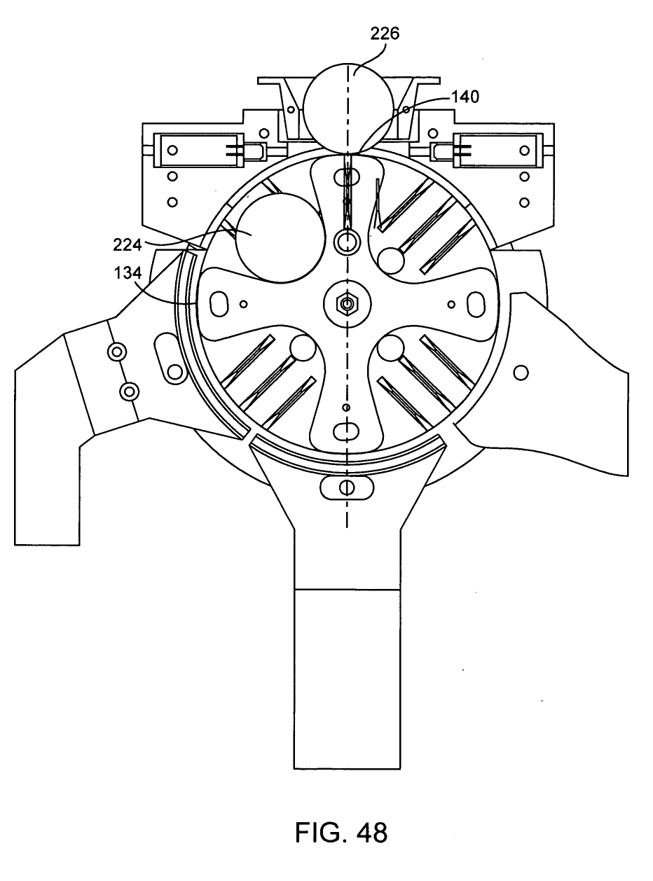

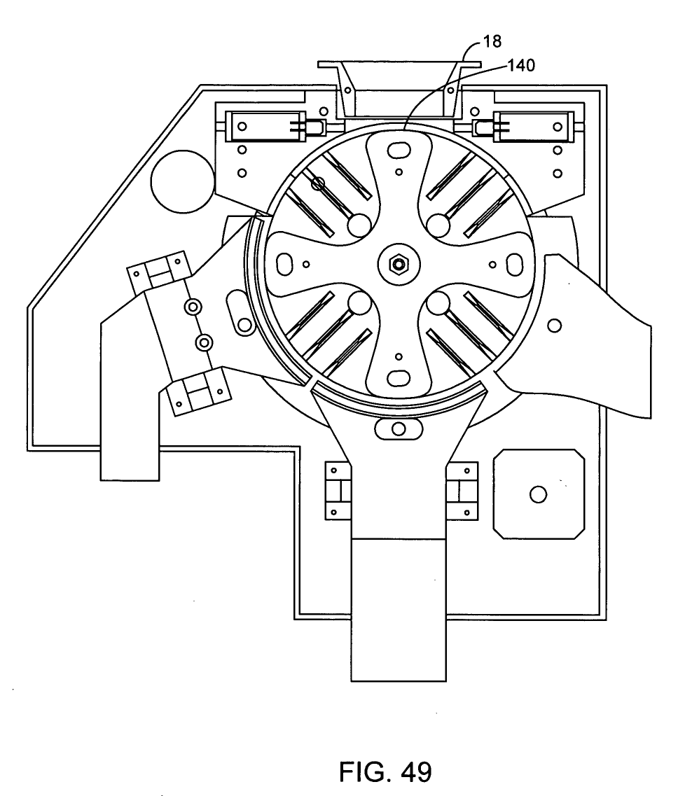

FIG. 47 illustrates a close-up view of the token entry bezel 18 showing a first token 224 having been inserted into the entry bezel 18 and is shown at rest in a rotating disk receptacle. Further, an additional token 226 is shown having been inserted into the entry bezel and is shown resting upon the top of token 224. As described above, when the rotating disk 88 rotates counterclockwise, a rib of the rotating disk, such as rib 136 further would block the token 226 from entering the rotating disk 88 as shown in FIG. 48. As shown in FIG. 49, when the media processor 10 is out of service, such as when it is being serviced by a technician, the rotating disk 88 is rotated so that a rib, such as rotating disk rib 140 is located at the 12 o'clock position to prevent a token from exiting the entry bezel 18 and entering the rotating disk 88.

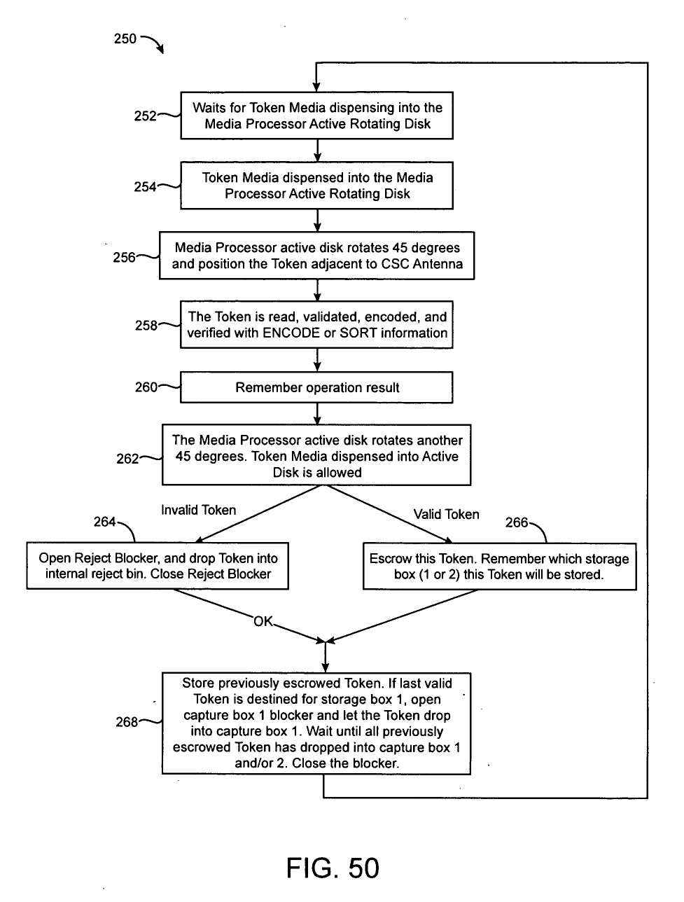

Referring to FIGS. 15-25, for the operation of the media processor and the encoder or sorter mode, and further referring to FIG. 50 which illustrates the operation of the media processor when in the encoder or sorter mode. When the media processor is in the encoder or sorter mode, the media processor processes tokens that have been used in the field and when tokens are fed into the media processor, they are encoded and sorted into different storage boxes. The media processor can also initialize and add value to any newly issued tokens. The operation flow of the media processor while in the encoder or sorter mode is illustrated in flow chart 250. At step 252, the media processor is ready for a token to be inserted into the entry bezel of the media processor. At step 254, the token is dispensed into the media processor and comes to rest in the rotating disk 88. At step 256, the rotating disk 88 rotates approximately 45° and positions the token adjacent to the CSC antenna 198. At step 258, the token is read, validated, encoded, and/or verified with encode or sort information. At step 260, the media processor stores into memory the results of the operation. At step 262, the media processor moves the rotating disk 88 another approximately 45°, which allows the rotating disk 88 to accept another token media into the rotating disk through the entry bezel. At step 264, if the first token inserted was invalid, the first blocker 102 is opened and the first token is accepted into an internal reject bin. Then the first blocker 102 is closed. In contrast, at step 266, if the first token inserted was valid, the token is escrowed, or kept in the rotating disk 88 by not opening the first blocker 102. At step 268, the escrowed tokens are moved through the media processor by the rotating disk 88 to the appropriate pathway in combination with the operation of the second blocker 104 to drop any escrowed tokens into a first box if the second blocker 104 is opened, or a second box if the second blocker 104 remains closed and the token takes the default passageway to the second box. The process then returns to step 252 waiting for the next token to be inserted into the media processor.

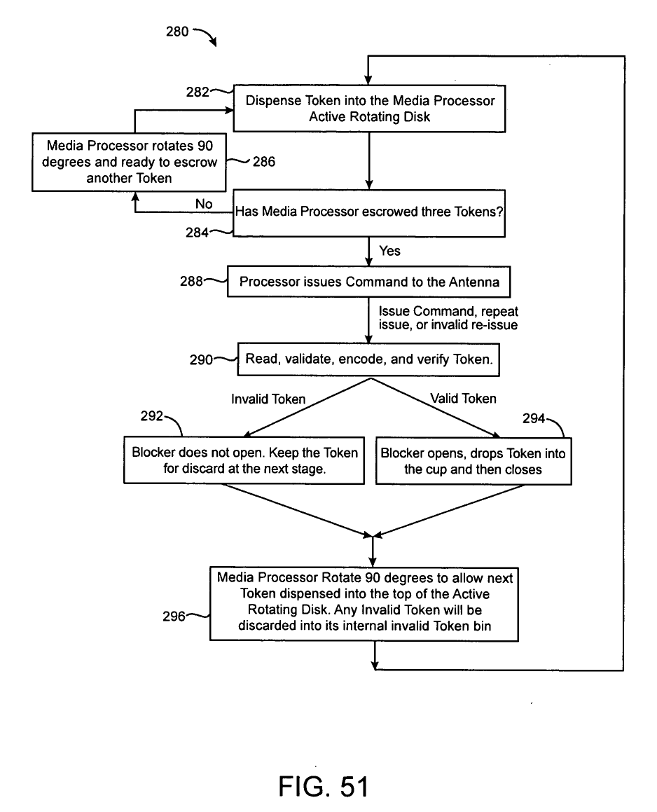

FIG. 51 in flow chart 280 illustrates the media processor in the ticket vending machine mode and the booking office machine mode. In both of these modes, the media processor initializes and issues tokens to passengers, wherein the tokens have an initial value as purchased by the passenger. Refer to phase 26-31 for the operation of the media processor in the ticket vending machine mode or the booking office machine mode. At step 282, the token is inserted into the media processor and, more particularly, the rotating disk 88. At step 284, the media processor determines whether there are three escrowed tokens in the rotating disk. If not, at step 286, the media processor rotates approximately 90° to be in a position ready to accept another token into the rotating disk 88. Once the rotating disk 88 has accepted three tokens, then at step 288, the control board 164 issues a command to the antenna to read, validate, encode, or verify the token, as shown in step 290. If the token is invalid, then at step 292 the second blocker 104 remains closed and the token remains in the rotating disk 88 to be discarded to the internal invalid token bin. In contrast, at step 294, if the token is valid, in an exemplary embodiment only, blocker 104 opens, and the token drops into the cup and the blocker then closes. At step 296, the rotating disk rotates approximately 90° to allow the next token to be accepted into the rotating disk. Any invalid token will be discarded into the internal invalid token bin, and then the process repeats.

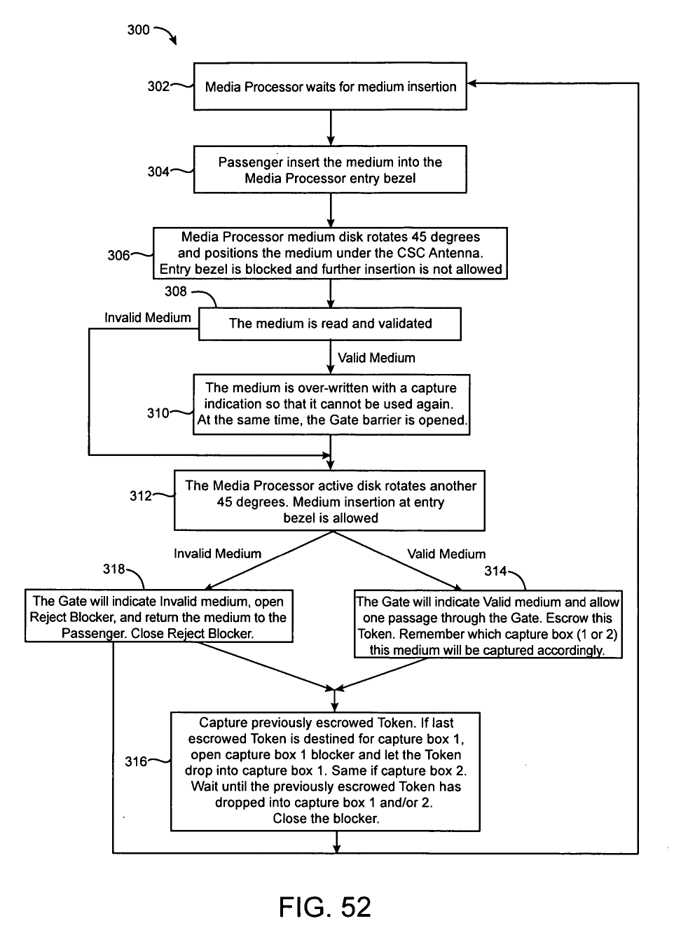

According to FIG. 52, when the media processor is in the gate entry or gate exit mode, the media processor validates and captures a token according to flow diagram 300. At step 302, the media processor waits for a medium to be inserted. At step 304, the passenger inserts a medium into the media processor entry bezel. At step 306, the media processor disk rotates, in this embodiment, 45° and positions the medium adjacent to or under the CSC antenna. The rotating disk is reoriented so that the entry bezel is blocked from allowing another medium to be inserted into to the media processor. At step 308, the medium is read by the CSC antenna and validated by the processor through the CSC antenna. If the medium is valid, at step 310, the entry or exit gate barrier is opened so that the user is allowed to enter an area or exit an area. At step 312, the media processor disk rotates approximately another 45°. This additional rotation of the disk allows the media processor to accept another medium at the entry bezel. If the medium is invalid, such as if it is counterfeit or does not have enough value written to the token to allow entry or exit from the specified area, then the process advances to step 312. After step 312, if the medium is valid then at step 314 the entry or exit gate will indicate to the user via the display that the medium is valid and that the entry or exit gate will allow passage of the user through the gate. The media processer escrows this token, as described above. The media processor then remembers in memory, such as RAM which exit path and/or which vault the medium is to be captured when the medium is adjacent to the appropriate blocker and exit path. At step 316, the media processor determines which capture box the previously escrowed media will be captured. If the medium is invalid, then at step 318 the gate would indicate to the user via the display that the medium is invalid and the appropriate blocker, such as the rejection blocker, will open which allows the medium to be returned to the passenger via the rejection pathway. The rejection blocker is then closed. From step 318, the process also goes to step 316. Therefore, it is possible that there are 0, 1, or 2 previously escrowed tokens to be captured. The processor waits until the previously escrowed media that are adjacent to the appropriate blocker and pathway are fully dropped into one of the vaults before the media processor goes back to step 302. For example, if the last two inserted escrowed media were rejected, there would not be any medium captured in the rotating disk. If the last inserted medium was accepted, and the second to last medium was rejected, at most there would be one medium available for capture into the first vault. If this medium is captured in vault 1, there would not be any medium to be captured into vault 2 in the next medium insertion and processing steps. If the last two inserted medium were accepted, and no medium had been captured to vault 1, then the second to last medium would be dropped into and captured into vault 2 automatically and it would be determined by the media processor if the last medium should be captured into the first vault. If so, then the second blocker would be opened and then closed to drop the medium to the first vault. If the last escrowed medium is determined by the media processor to be sent to vault 1, then the appropriate blocker is opened to allow the medium to follow the passageway to allow the medium to fall into vault 1. Next, the appropriate blockers are closed and the process returns to step 302 where the media processor waits for a medium to be inserted. The escrowed token has dropped into the capture box when the token leaves the rotating disk and passes the appropriate chute sensor in the pathway to the capture box.

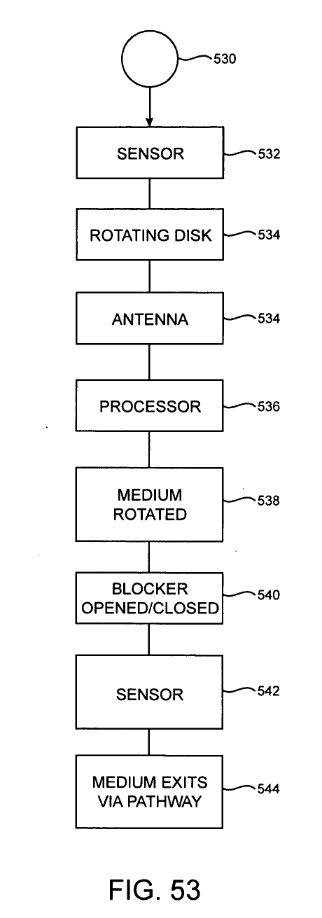

FIG. 53 illustrates a functional flow diagram of the media processor according to the present disclosure. A medium 530 is inserted into the media processor and the presence of the insertion of the medium 530 into the media processor is detected by sensor 532. The medium 530 tends to rest in the rotating disk at block 534. The rotating disk then rotates the medium so that it is adjacent to an antenna as shown in block 534. The medium is then read and validated and information is otherwise exchanged via the antenna as instructed and controlled by the processor as shown in block 536. The rotating disk then rotates the medium as shown in block 538 so that the medium is rotated to be adjacent to the appropriate blocker and exit pathway as shown in block 538. The rotation of the medium by the rotating disk may take place incrementally, for example, the medium may be escrowed or kept in the rotating disk until it is advanced by the assertion of additional medium or the rotating disk may rotate the medium directly to the appropriate location, such as the case if the medium is invalid and rejected by the media processor. When the rotating disk rotates the medium to the appropriate location adjacent to the blocker and appropriate pathway as determined by the processor, the appropriate blocker 540 is opened and allows the medium to drop out of the rotating disk. After the exit of the medium into the pathway 544 is detected by the sensor 542, the appropriate blocker 540 will be closed.

Although this disclosure has been shown and described with respect to detailed embodiments, those skilled in the art will understand that various changes in form and detail may be made without departing form the scope of the claimed disclosure. For example, the media processor disclosed herein may be utilized in any situation where a medium that represents a value is to be processed. In yet another embodiment, the present disclosure may be used in a slot machine.

1. A media processor for reading from, writing to, or sorting a medium, comprising:
an entry bezel for accepting the medium into the media processor;
a wireless contactless reader/writer for reading from, writing to, or sorting the medium;
at least one exit pathway for the medium to exit the media processor; and
a rotatable disk for moving the medium from the entry bezel to the transmitter and receiver and to the at least one or more exit pathways where the media can be sorted.

2. The media processor of claim 1, further comprising multiple exit pathways.

3. The media processor of claim 2, wherein each medium exits the media processor via a determined exit pathway based on the results of the writing, reading, or sorting of the medium.

4. The media processor of claim 3, further comprising at least one blocker to either block the exit of a medium from the rotatable disk or to allow the exit of a medium from the rotatable disk to one of the exit pathways.

5. The media processor of claim 4, wherein the number of blockers is equal to one less or the same of the number of exit pathways.

6. The media processor of claim 2, wherein at least one of the exit pathways is a reject medium pathway.

7. The media processor of claim 6, wherein at least one of the exit pathways is a vault medium pathway.

8. The media processor of claim 6, wherein the medium exits to a rejection receptacle.

9. The media processor of claim 7, wherein the medium exits to a vault.

10. The media processor of claim 3, further comprising a sensor at each exit pathway to sense the passing of the medium through the exit pathway.

11. The media processor of claim 1, further comprising a sensor at the entry bezel to sense the medium being inserted into the intake.

12. The media processor of claim 11, further comprising at least one sensor at the rotatable disk to sense the medium being located in the rotatable disk.

13. The media processor of claim 1, wherein the entry bezel further includes a plurality of grooves oriented in the direction of travel of the medium into the rotatable disk.

14. The media processor of claim 1, wherein the rotatable disk includes a plurality of medium receptacles.

15. The media processor of claim 14, wherein the rotatable disk includes at least one sensor to sense the presence of media in the medium receptacles.

16. The media processor of claim 1, wherein the media processor is used to encode media.

17. The media processor of claim 1, wherein the media processor is used to sort media.

18. The media processor of claim 1, wherein the media processor is used to issue media of value at a point of purchase.

19. The media processor of claim 13 wherein the rotatable disk provides positive movement of a low mass medium, such as a plastic token in a variety of environments, including contaminated environments where free falling or sliding technique cannot be used when the friction of the contaminated environment is higher than the mass of the medium.

20. The media processor of claim 1, wherein the media processor controls access to or exit from a controlled area.

21. The media processor of claim 1, wherein the wireless contactless reader/writer includes at least one antenna that may be located anywhere within the path of the medium.

22. The media processor of claim 21, wherein the antenna is located between pathways for efficient processing of the medium.

23. A token processor for processing a token, comprising:
an entry bezel for accepting a token into the token processor;
a transmitter and receiver for reading from, writing to, the token;
a rotatable disk having a plurality of token receptacles and being adapted to accept a token from the entry bezel;
a plurality of sensors located within the token processor to determine the existence of the tokens with the token processor;
a plurality of exit paths from the token processor; and
a plurality of blockers adjacent to the rotatable disk, the blockers controlling the state of the exit paths so that tokens with insufficient value or invalid tokens may be rejected from the token processor and so that tokens with sufficient value or valid tokens may be retained within the token processor.

24. The token processor of claim 23, wherein the blockers control the flow of the tokens from the rotatable disk to the exit paths, so that tokens with insufficient value or invalid tokens are rejected from the token processor and so that tokens with sufficient value or valid tokens are be retained within a vault located within the token processor.

25. A media processor system, comprising:
a media processor, comprising:
an entry bezel for accepting at least one medium at one time into the media processor;
a processor for reading from, writing to, or sorting the medium;
a rotatable disk having a plurality of medium receptacles, and the rotatable disk being adapted to accept the medium from the entry bezel;
a plurality of sensors located within the media processor to determine the existence of the medium with the media processor;
a plurality of exit paths from the media processor; and
a plurality of blockers adjacent to the rotatable disk, the blockers controlling the state of the exit paths so that medium with insufficient value or invalid medium may be rejected from the media processor and so that medium with sufficient value or valid medium may be retained within the media processor;
the medium having readable and writable memory so that information, such as value, may be read from and writable to the medium;
the media processor being capable of encoding, sorting, or issuing media, and wherein the media processor together with the medium controls access to a location, or attraction by accepting the medium and permitting access to the location, or attraction.

26. The media processor system of claim 25, wherein the media system utilizes wireless read and write functions.

27. A media processor, comprising:
means for intaking at least one medium at one time into the media processor;
means for processing at least one medium at one time;
means for storing more than one medium at one time in the media processor either before or after the medium have been processed; and
means for each medium to exit the media processor to a determined location based on the results of the processing of the medium.

28. A method of controlling access to a location, comprising:
intaking at least one medium at one time into a media processor;
processing at least one medium at one time;
storing more than one medium at one time in the media processor either before or after the medium have been processed; and
providing exit pathways for each medium to exit the media processor to a determined location based on the results of the processing of the medium.

29. A media processor, comprising:
a processor; and
an entry bezel that includes a first opposing surface and a second opposing surface, and wherein the first and second opposing surfaces are configured to direct a medium into the processor.

30. The media processor of claim 29, wherein the rotating disk receptacle includes a plurality of grooves in the direction of travel of the medium into the media processor.

31. The media processor of claim 14, wherein the rotatable disk is reversible and is capable of escrowing medium.
